(19) United States
(12) Patent Application Publication
(10) Pub. No.: US 2026/0091992 A1
(43) Pub. Date: Apr. 2, 2026

(54) MODIFIED CHITOSAN POLYMERS FOR DYE-CONTAMINATED WATER PURIFICATION

(71) Applicant: King Fahd University of Petroleum and Minerals, Dhahran (SA)

(72) Inventors: Mahmoud Atef ABDULHAMID, Dhahran (SA); Ibtisam Ibrahim BINSHARFAN, Dhahran (SA)

(73) Assignee: King Fahd University of Petroleum and Minerals, Dhahran (SA)

(21) Appl. No.: 18/903,104

(22) Filed: Oct. 1, 2024

(51) Int. Cl. C02F 1/28; C02F 101/30; C02F 101/38

(52) U.S. Cl. CPC C02F 1/286; C02F 2101/308; C02F 2101/38; C02F 2101/40

(57) ABSTRACT

A method of purifying dye-contaminated water. The method includes alkylating a chitosan backbone of Formula 1 with a fatty acid chloride to obtain an adsorptive polymer matrix formed of a modified chitosan polymer. This matrix is characterized by a sponge-like structure, formed by repeating units of the chitosan backbone. The resulting adsorptive polymer matrix is then mixed with the dye-contaminated water and agitated to facilitate the removal of dye from contaminated water.

### BACKGROUND

### Technical Field

The present disclosure is directed to a water purification method, and particularly a method of purifying dye-contaminated water using a modified chitosan polymer.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present invention.

The increasing concern of contaminated wastewater due to the production of pollutants by various industries presents a public health and environmental protection risk, posing a challenge to conventional water treatment systems. These contaminants include a range of organic pollutants, such as dyes, pharmaceuticals, and surfactants, as well as inorganic pollutants like heavy metal ions and substances contributing to eutrophication. Dye contamination from the textile industry is an increasing environmental concern due to the large volumes of wastewater generated during dyeing processes.

Textiles are treated with a variety of synthetic dyes, many of which are not fully absorbed by the fabrics, resulting in a significant amount being discharged into water bodies. These dyes are typically complex, stable chemical compounds, making them resistant to natural degradation. Around 84,000 tons of synthetic dyes are produced annually, constituting roughly 20% of total industrial water pollution. Even at low concentrations, these dyes are highly visible and can negatively impact human life and aquatic organisms due to their complex molecular structures, stability, and the toxic intermediates produced during partial degradation.

Several technologies have been developed to remove dye pollutants from industrial wastewater, such as chemical precipitation, membrane separation, chemical oxidation, biological treatment, ozonation, solvent extraction, coagulation, adsorption, electrochemical methodology, photocatalytic degradation, and reverse osmosis. Among these various methods, adsorption is considered the most promising approach due to its low cost, availability, ease of operation, and high efficiency. In recent years, there has been a concerted focus on developing more efficient and cost-effective adsorbents derived from natural biomass resources. More recently, bio-based materials such as cellulose, alginate, lignin, starch, and chitosan have been targeted for adsorption treatments due to their numerous advantages, including low manufacturing costs, biodegradability, affordability, biocompatibility, hydrophilicity, and widespread availability. These materials have shown great promise as effective dye adsorbents in water treatment applications. Chitosan is a biopolymer derived from chitin found in the exoskeletons of crustaceans, such as shrimp and crabs. Chitosan's unique chemical structure makes it particularly effective in the removal of dye contaminants from water. Specifically, chitosan's amine groups are protonated at low pH, creating positive charges that attract negatively charged dye molecules through chemisorption.

Further research has been dedicated to enhancing the adsorption capacity of chitosan through chemical modifications. Although chitosan is a promising adsorbent, without modification, chitosan can adsorb a large variety of molecules without specificity. Further, due to the large bodies of water facing contamination, there is a concern about the efficiency of chitosan as an adsorbent in large wastewater sources. Therefore, there exists a need to develop newer derivatives of chitosan to enhance its dye removal properties with greater selectivity and efficiency.

Accordingly, one object of the present disclosure is a method to purify dye-contaminated water by utilizing an adsorptive polymer matrix formed from a modified chitosan polymer, leading to increased adsorption capacity.

### SUMMARY

In an exemplary embodiment, a method of purifying dye-contaminated water is described. The method comprises alkylating a chitosan backbone of Formula 1 with a fatty acid chloride to obtain an adsorptive polymer matrix.

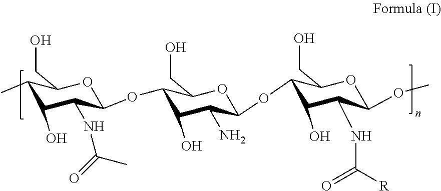

The polymer matrix is formed of a modified chitosan polymer having repeating units of the chitosan backbone. The method further involves mixing the adsorptive polymer matrix with the dye-contaminated water while agitating at a temperature of 15 to 35° C. to ensure contact between the adsorptive polymer matrix and the dye-contaminated water, thereby obtaining maximum adsorption capacity. The adsorptive polymer matrix is in the form of a sponge.

In some embodiments, the adsorptive polymer matrix has a maximum adsorption capacity (Qₘₐₓ) of 200 mg·g⁻¹ (milligrams/grams) to 400 mg·g⁻¹ (milligrams/grams).

In some embodiments, the modified chitosan polymer has a degree of deacetylation of at least 60%

In some embodiments, the adsorptive polymer matrix has a maximum adsorption capacity (Qₘₐₓ) of 238 mg·g⁻¹ to 380 mg·g⁻¹.

In some embodiments, the modified chitosan polymer has a degree of deacetylation of at least 75%

In some embodiments, the adsorptive polymer matrix has a removal efficiency of a dye of at least 42%.

In some embodiments, the dye is selected from the group consisting of methyl orange, methylene blue, and rhodamine B.

In some embodiments, a removal efficiency of the adsorptive polymer matrix decreases by less than 10% after a removal cycle.

In some embodiments, the adsorptive polymer matrix has an adsorption rate (k₂) of 2 to 72 mg g⁻¹ min⁻¹.

In some embodiments, the alkyl chain comprises 8 carbons.

In some embodiments, the method further comprises deacetylating chitin with a monoprotic acid to obtain the chitosan backbone.

In some embodiments, the obtained chitosan backbone is maintained at a pH of 6 to 8.

In some embodiments, the fatty acid chloride is selected from the group consisting of hexanoyl chloride, heptanoyl chloride, octanoyl chloride, and nonanoyl chloride.

In some embodiments, the fatty acid chloride is specifically octanoyl chloride.

In some embodiments, the monoprotic acid selected from the group consisting of acetic acid (CH₂COOH), hydrochloric acid (HCl), nitric acid (HNO₃), formic acid (CH₂O₂), and hydrofluoric acid (HF).

In some embodiments, the monoprotic acid is acetic acid.

In some embodiments, the method further comprises filtering the modified chitosan polymer, and then precipitating the modified chitosan polymer in acetonitrile. Finally, the method comprises freeze drying the modified chitosan polymer to obtain the sponge.

In some embodiments, the modified chitosan polymer is freeze dried at a temperature of −65 to ˜105° C. for 8 to 24 hours (h).

In some embodiments, the method comprises agitating the adsorptive polymer matrix with the dye-contaminated water at an agitation speed of 150 to 450 rotations per minute (rpm) for 8 to 36 h.

In some embodiments, the method comprises agitating the adsorptive polymer matrix with the dye-contaminated water at an agitation speed of 300 rpm for 24 h.

The foregoing general description of the illustrative embodiments and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A is a flowchart depicting a method of purifying dye-contaminated water, according to certain embodiments.

FIG. 1B is a schematic illustration for preparing modified chitosan sponges and their use in dye removal application, according to certain embodiments.

FIG. 2 is a schematic illustration depicting a synthetic pathway of chitosan modification with fatty acids, according to certain embodiments.

FIG. 3 shows chemical structures of methyl orange (MO), methylene blue (MB) and rhodamine dye (RB), according to certain embodiments.

FIG. 4A shows solid-state 13C nuclear magnetic resonance (NMR) peaks for pristine chitosan (F0) and its derivatives or modified chitosan (F1-F4), according to certain embodiments.

FIG. 4B shows a Fourier transform infrared (FTIR) spectra for the pristine chitosan (F0) and its derivatives (F1-F4), according to certain embodiments.

FIG. 4C shows a thermogravimetric analysis (TGA) under a N₂ atmosphere for the pristine chitosan (F0) and its derivatives (F1-F4), according to certain embodiments.

FIG. 4D shows a clear wide-Angle X-ray diffraction (WXRD) patterns for the pristine chitosan (F0) and its derivatives (F1-F4), according to certain embodiments.

FIG. 5A shows a scanning electron microscope (SEM) images pristine (F0) chitosan, at different magnifications, according to certain embodiments.

FIG. 5B to FIG. 5E show SEM images of modified chitosan sponges (F1-F4), respectively, at different magnifications, according to certain embodiments.

FIG. 5F shows a scanning electron microscope (SEM) images pristine (F0) chitosan, at different magnifications, according to certain embodiments.

FIG. 5G to FIG. 5J show SEM images of the modified chitosan sponges (F1-F4) at at different magnifications, according to certain embodiments.

FIG. 6A depicts removal efficiency of the modified chitosan sponges (F1-F4) of methylene blue (MB), according to certain embodiments.

FIG. 6 B depicts removal efficiency of the modified chitosan sponges (F1-F4) of methyl orange (MO), according to certain embodiments.

FIG. 6C depicts removal efficiency of the modified chitosan sponges (F1-F4) of rhodamine B (RB), according to certain embodiments.

FIG. 7 shows images of modified chitosan sponges after 24 hrs of adsorption using three different dye solutions (RB, MO, and MB) at different concentrations, according to certain embodiments.

FIG. 8 is a pictorial image depicting the color of the MO solution before and after 30 minutes of adsorption by the modified chitosan sponge, according to certain embodiments.

FIG. 9 is a pictorial image showing MO solution before and after direct filtration using the modified chitosan sponge, according to certain embodiments.

FIG. 10A is an absorption spectrum showing the removal of MB dye at various concentrations with the modified chitosan sponge F1, according to certain embodiments.

FIG. 10B is an absorption spectrum showing the removal of MO dye at various concentrations with the modified chitosan sponge F1, according to certain embodiments.

FIG. 10C is an absorption spectrum showing the removal of RB dye at various concentrations with the modified chitosan sponge F1, according to certain embodiments.

FIG. 10D is an absorption spectrum showing the removal of MB dye at various concentrations with the modified chitosan sponge F2, according to certain embodiments.

FIG. 10E is an absorption spectrum showing the removal of MO dye at various concentrations with the modified chitosan sponge F2, according to certain embodiments.

FIG. 10F is an absorption spectrum showing the removal of RB dye at various concentrations with the modified chitosan sponge F2, according to certain embodiments.

FIG. 10G is an absorption spectrum showing the removal of MB dye at various concentrations with the modified chitosan sponge F3, according to certain embodiments.

FIG. 10H is an absorption spectrum showing the removal of MO dye at various concentrations with the modified chitosan sponge F3, according to certain embodiments.

FIG. 10I is an absorption spectrum showing the removal of RB dye at various concentrations with the modified chitosan sponge F3, according to certain embodiments.

FIG. 10J is an absorption spectrum showing the removal of MB dye at various concentrations with the modified chitosan sponge F4, according to certain embodiments.

FIG. 10K is an absorption spectrum showing the removal of MO dye at various concentrations with the modified chitosan sponge F4, according to certain embodiments.

FIG. 10L is an absorption spectrum showing the removal of RB dye at various concentrations with the modified chitosan sponge F4, according to certain embodiments.

FIG. 11A shows the UV-Vis spectra of mixed solution (15 mg L⁻¹) of MO and MB mixture, comparing the absorption as a function of wavelength for a blank solution (before) versus the mixed solution (after) by the modified chitosan sponge F1, according to certain embodiments.

FIG. 11B shows the UV-Vis spectra of mixed solutions (15 mg L⁻¹) of MO and MB mixture for the blank solution (before) versus the mixed solution (after) by the modified chitosan sponge F2, according to certain embodiments.

FIG. 11C shows the UV-Vis spectra of mixed solutions (15 mg L⁻¹) of MO and MB mixture for the blank solution (before) versus the mixed solution (after) by the modified chitosan sponge F3, according to certain embodiments, according to certain embodiments.

FIG. 11D shows the UV-Vis spectra of mixed solutions (15 mg L⁻¹) of MO and MB mixture for the blank solution (before) versus the mixed solution (after) by the modified chitosan sponge F4, according to certain embodiments.

FIG. 11E shows the UV-Vis spectra of mixed solution (15 mg L⁻¹) of MO and RB mixture, comparing the absorption as a function of wavelength for a blank solution (before) versus the mixed solution (after) by the modified chitosan sponge F1, according to certain embodiments.

FIG. 11F shows the UV-Vis spectra of mixed solutions (15 mg L⁻¹) of MO and RB mixture for the blank solution (before) versus the mixed solution (after) by the modified chitosan sponge F2, according to certain embodiments.

FIG. 11G shows the UV-Vis spectra of mixed solutions (15 mg L⁻¹) of MO and RB mixture for the blank solution (before) versus the mixed solution (after) by the modified chitosan sponge F3, according to certain embodiments, according to certain embodiments.

FIG. 11H shows the UV-Vis spectra of mixed solutions (15 mg L⁻¹) of MO and RB mixture for the blank solution (before) versus the mixed solution (after) by the modified chitosan sponge F4, according to certain embodiments.

FIG. 11I shows the UV-Vis spectra of mixed solution (15 mg L⁻¹) of MO, RB and MB mixture, comparing the absorption as a function of wavelength for a blank solution (before) versus the mixed solution (after) by the modified chitosan sponge F1, according to certain embodiments.

FIG. 11J shows the UV-Vis spectra of mixed solutions (15 mg L⁻¹) of MO, RB and MB mixture for the blank solution (before) versus the mixed solution (after) by the modified chitosan sponge F2, according to certain embodiments.

FIG. 11K shows the UV-Vis spectra of mixed solutions (15 mg L⁻¹) of MO, RB and MB mixture for the blank solution (before) versus the mixed solution (after) by the modified chitosan sponge F3, according to certain embodiments, according to certain embodiments.

FIG. 11L shows the UV-Vis spectra of mixed solutions (15 mg L⁻¹) of MO, RB and MB mixture for the blank solution (before) versus the mixed solution (after) by the modified chitosan sponge F4, according to certain embodiments.

FIG. 12A shows a removal percentage of MB and MO from a mixed dye solution including MB and MO with the modified chitosan sponges (F1-F4), according to certain embodiments.

FIG. 12B shows a removal efficiency of RB and MO from a mixed dye solution including RB and MO with the modified chitosan sponges (F1-F4), according to certain embodiments.

FIG. 12C shows a removal efficiency of MB, MO, and RB from a mixed dye solution including MB, MO, and RB with the modified chitosan sponges (F1-F4), according to certain embodiments.

FIG. 13 shows the recyclability of the modified chitosan sponge for MO adsorption, according to certain embodiments.

FIG. 14A-FIG. 14D shows adsorption isotherm plots depicting adsorption performance of MO using the modified chitosan sponges (F1-F4), according to certain embodiments.

FIG. 14E shows pseudo-first-order kinetics plot depicting the adsorption performance of MO using chitosan sponges, according to certain embodiments.

FIG. 14F shows pseudo-second-order kinetics plot depicting the adsorption performance of MO using chitosan sponges, according to certain embodiments.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Embodiments of the present disclosure will now be described more fully hereinafter with reference to the accompanying drawings, in which some, but not all embodiments of the disclosure are shown.

As used herein, the words “about,” “approximately,” or “substantially similar” may be used when describing magnitude and or position to indicate that the value and/or position described is within a reasonable expected range of values and/or positions. For example, a numeric value may have a value that is +/−0.1% of the stated value (or range of values), +/−1% of the slated value (or range of values), +/−2% of the stated value (or range of values), +/−5% of the slated value (or range of values), +/−10% of the staled value (or range of values), +/−15% of the stated value (or range of values), or +/−20% of the stated value (or range of values). Within the description of this disclosure, where a numerical limit or range is stated, the endpoints are included unless stated otherwise. All values and subranges within a numerical limit or range are specifically included as if explicitly written out.

The present disclosure is intended to include all hydration states of a given compound or formula, unless otherwise noted or when heating a material.

In addition, the present disclosure is intended to include all isotopes of atoms occurring in the present compounds and complexes. Isotopes include those atoms having the same atomic number but different mass numbers. By way of general example, and without limitation, isotopes of hydrogen include deuterium and tritium.

As used herein, the term “purifying” refers to a process that facilitates a chemical reaction method by applying a formula and obtained high degree of purification.

As used herein, the term “dye” refers a substance used to impart color to materials by absorbing certain wavelengths of light while reflecting others, resulting in the visible coloration of the material.

As used herein, the term “dye contamination” refers to the unintended presence of dye substances in environments, materials, or products. Dyes may be considered contaminants because of their strong chemical properties, which allow them to adhere to surfaces and permeate through various mediums. This contamination can occur during manufacturing, transportation, or improper disposal. The persistence and solubility of dyes in water and other solvents make them difficult to remove, leading to potential environmental and health hazards.

As used herein, the term “alkylating” refers to the chemical process in which an alkyl group is transferred to an organic molecule, typically through the reaction of an alkyl halide with a nucleophile. This process is widely used in organic chemistry to modify the structure and properties of molecules.

As used herein, the term “chitosan backbone” refers to the primary structural framework of chitosan, a natural polysaccharide derived from chitin. The chitosan backbone is composed of repeating units of β-(1→4)-linked D-glucosamine and N-acetyl-D-glucosamine.

As used herein, the term ‘degree of acetylation’ (DA) refers to the proportion of N-acetyl groups (—COCH₃) present on the glucosamine units of chitosan. It is typically expressed as a percentage, representing the ratio of acetylated to deacetylated units in the polymer chain.

As used herein, the term “agitating” refers to refers to the process of stirring, shaking, or otherwise moving a substance to create motion within it. Agitation is typically employed to ensure uniform mixing, prevent settling of particulates, or facilitate chemical reactions by increasing the contact between reactants.

As used herein, the term “adsorption capacity” refers to the maximum quantity of a substance that a material can adsorb onto its surface under specific conditions.

As used herein, the term “removal efficiency” refers to the percentage of a target substance eliminated from a system or process. It is a crucial measure in applications like filtration, water treatment, and pollution control.

As used herein, the term, “chitosan” refers to a biopolymer material derived from chitin found in crustacean exoskeletons. Chitosan is characterized by its linear structure of β-(1→4)-linked D-glucosamine and N-acetyl-D-glucosamine units.

Modified chitosan polymers, which are chitosan derivatives altered through chemical or physical means, are designed to enhance properties such as solubility, mechanical strength, biocompatibility, and functionality. These modifications significantly improve their effectiveness in purifying dye-contaminated water. As a result, chitosan-modified polymers present a versatile and effective solution for a variety of dye removal applications, demonstrating their suitability across different contexts of water purification.

As used herein, the term, “fatty acid chloride” refers to a reactive organic compound derived from fatty acids, where the carboxyl group is converted into an acid chloride group (—COCl). Fatty acid chlorides are commonly used in chemical synthesis and modifications, such as in the creation of surfactants, esters, and in the modification of polymers. Their reactivity makes them valuable in various industrial applications, including the production of fatty acid derivatives and in polymer chemistry.

As used herein, the term “degree of deacetylation” refers to the proportion of the number of acetyl groups present on the chitin prior to deacetylation with a monoprotic acid to the number of acetyl groups present on the chitosan backbone after deacetylation, expressed as a percentage This metric indicates the extent to which chitin has been converted into chitosan, affecting the polymer's solubility, functionality, and application properties.

Aspects of the present disclosure are directed toward a method producing a modified chitosan polymer and a method of removing a dye from water that is polluted or contaminated with the modified chitosan polymer. The modified chitosan polymer displayed increased stability in water and dye removal efficiency. The modified chitosan polymer further displayed increased reusability over five adsorption-desorption cycles.

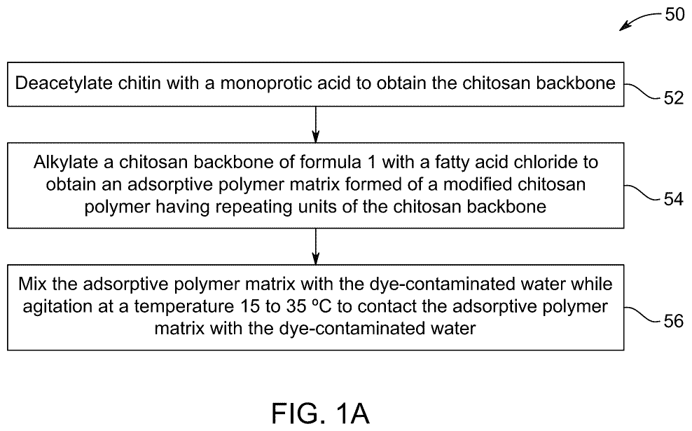

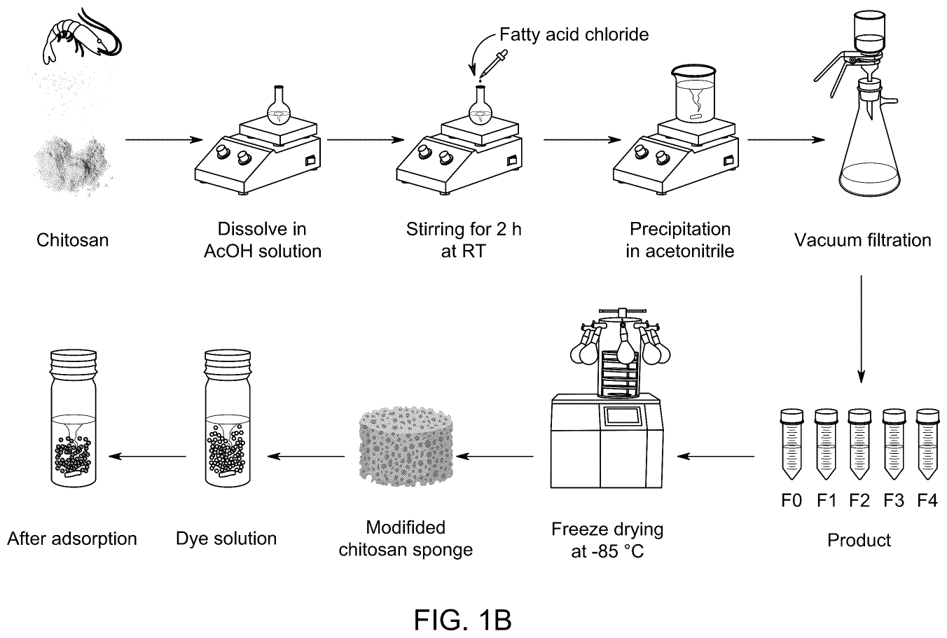

FIG. 1A illustrates a schematic flow chart of a method for purifying dye contaminated water. The water, for example, may be industrial wastewater, tap water, river water, surface water that collects on the ground or in a stream, aquifer, river, lake, reservoir or ocean, ground water that is obtained by drilling wells, run-off, industrial water (e.g. contaminated water generated by textile industry), public water storage towers, public recreational pools and bottled water. The water may be contaminated with one or more dyes. The dyes may be cationic dyes or an anionic dye or a combination of both. Some of the most common dyes involved in water pollution includes azo dyes, reactive dyes, vat dyes, sulfur dyes, acid dyes, basic dyes, and the like. Azo dyes, characterized by the presence of an azo group (—N═N—), are synthetic compounds extensively utilized for their vibrant colors and chemical stability. Notable examples include Direct Red 28, Acid Orange 7, and Congo Red. Reactive dyes are designed to form covalent bonds with textile fibers. Vat dyes, which are water-insoluble in their native form, become soluble during the dyeing process, allowing their intense colors to persist and contaminate water sources. Sulfur dyes, exemplified by sulfur black 1, are commonly used for dark shades like black and brown. Acid dyes, including Acid Blue 25 and Acid Red 88, are primarily employed in the dyeing of wool, silk, and nylon. Their water-soluble nature, coupled with their high toxicity to aquatic life, makes them particularly hazardous in cases of water contamination. Basic dyes often used in the dyeing of acrylic fibers. When basic dyes contaminate aquatic environments, they can pose significant risks to both aquatic life and human health due to their persistent and potentially hazardous nature. Basic dyes, such as Basic Violet 10 (Rhodamine B) and Basic Blue 9 (Methylene Blue), are widely recognized for their intense, bright colors. In a preferred embodiment, the dye-contaminated water comprises at least one dye selected from the group consisting of methyl orange, methylene blue, and rhodamine B.

The method may be carried out in tanks, containers, or small-scale applications in both batch mode and fixed-bed or column mode. The order in which the method 50 is described is not intended to be construed as a limitation, and any number of the described method steps can be combined in any order to implement the method 50. Additionally, individual steps may be removed or skipped from the method 50 without departing from the spirit and scope of the present disclosure.

At step 52, method 50 comprises deacetylating chitin with monoprotic acid to obtain a chitosan backbone. Chitin may be obtained from the shells of crab, shrimp, squid, and other crustaceans or the cell walls of fungi either by enzymatic preparations or chemical hydrolysis using any procedure known to those of ordinary skill in the art. The chitin is deacetylated with the monoprotic acid to obtain the chitosan backbone. Suitable examples of monoprotic acids include, acetic acid (CH₂COOH), hydrochloric acid (HCl), nitric acid (HNO₃), formic acid (CH₂O₂), and hydrofluoric acid (HF). In a preferred embodiment, the monoprotic acid is acetic acid, preferably 95% acetic acid, preferably 97% acetic acid, preferably 98% acetic acid, and most preferably about 99% acetic acid to obtain the chitosan backbone. In a specific embodiment, the chitosan backbone may be obtained by treating chitin with monoprotic acid, specifically acetic acid, in a weight-by-volume ratio of 1:90 to 1:100, preferably 1:91 to 1:100, preferably 1:92 to 1:100, preferably 1:93 to 1:100, preferably 1:94 to 1:100, preferably 1:95 to 1:100, preferably 1:96 to 1:100, preferably 1:97 to 1:100, preferably 1:98 to 1:100, preferably 1:99 to 1:100, most preferably 1:99. The treating of the chitin with the monoprotic acid occurs for 24 to 48 hours, preferably 25 to 48 hours, preferably 26 to 48 hours, preferably 27 to 48 hours, preferably 28 to 48 hours, preferably 29 to 48 hours, preferably 30 to 48 hours, preferably 31 to 48 hours, preferably 32 to 48 hours, preferably 33 to 48 hours, preferably 34 to 48 hours, preferably 35 to 48 hours, preferably 36 to 48 hours, preferably 37 to 48 hours, preferably 38 to 48 hours, preferably 39 to 48 hours, preferably 40 to 48 hours, preferably 41 to 48 hours, preferably 42 to 48 hours, preferably 43 to 48 hours, preferably 44 to 48 hours, preferably 45 to 48 hours, preferably 46 to 48 hours, preferably 47 to 48 hours, most preferably about 48 hours. The pH of the chitosan backbone is in the range of about 6 to 8, preferably about 6.1 to 7.9, preferably about 6.2 to 7.8, preferably about 6.3 to 7.7, preferably about 6.4 to 7.6, preferably about 6.5 to 7.5, preferably about 6.6 to 7.4, preferably about 6.7 to 7.3, preferably about 6.8 to 7.2, preferably about 6.9 to 7.1, most preferably about 7. This can be adjusted using suitable buffers known in the art.

The concentration of the acetic acid and the treatment time plays affects the deacetylation of chitin. In one embodiment, the degree of deacetylation of the chitosan backbone is about 50 to 95%, preferably 55 to 90%, preferably 60 to 85%, preferably 65 to 85%, preferably 70 to 80%, preferably 75 to 85%, most preferably 80 to 85%. In a preferred embodiment, the degree of deacetylation of the chitosan backbone is 85%. A person of ordinary skill in art may be able to determine the degree of deacetylation by methods conventionally known. In one embodiment, the deacetylation of the chitin to obtain the chitosan backbone can be carried out at a temperature of 10 to 40° C., preferably 12 to 38° C., preferably 14 to 36° C., preferably 16 to 34° C., preferably 18 to 32° C., preferably 20 to 30° C., preferably 20 to 28° C., preferably 20 to 26° C., preferably 20 to 24° C., most preferably 20 to 22° C.

The chitosan backbone may include, but is not limited to, high molecular weight chitosan, low molecular weight chitosan, and partially deacetylated chitosan. In some embodiments, the chitosan has an average molecular weight of 100,000 to 375,000 g/mol, preferably 110,000 to 365,000 g/mol, preferably 120,000 to 355,000 g/mol, preferably 130,000 to 345,000 g/mol, preferably 140,000 to 335,000 g/mol, preferably 150,000 to 325,000 g/mol, preferably 160,000 to 315,000 g/mol, preferably 170,000 to 310,000 g/mol, preferably 180,000 to 310,000 g/mol, most preferably 190,000 to 310,000 g/mol.

The chitosan backbone is the compound of Formula (I). In a preferred embodiment, R represents an alkyl chain comprising 5 to 8 carbons, preferably 5 carbons, preferably 6 carbons, preferably 7 carbons, and most preferably about 8 carbon atoms, and n represents a positive integer greater than 0.

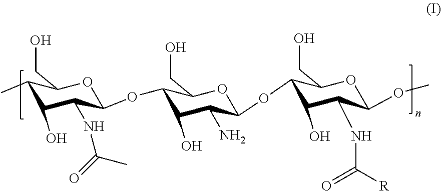

The term “alkyl,” as used herein, refers to a straight, branched, or cyclic hydrocarbon fragment, with a general formula of CₙH₂ₙ₊₁, wherein n ranges from 1 to 20, preferably 2 to 19, preferably 2 to 18, preferably 2 to 17, preferably 2 to 16, preferably 2 to 15, preferably 2 to 14, preferably 2 to 13, preferably 2 to 12, preferably 2 to 11, preferably 2 to 10, preferably 2 to 9, most preferably 2 to 8. Such hydrocarbon fragments include methyl, ethyl, propyl, isopropyl, butyl, isobutyl, t-butyl, pentyl, isopentyl, neopentyl, hexyl, isohexyl, 3-methylpentyl, 2,2-dimethylbutyl, 2,3-dimethylbutyl, vinyl, allyl, 1-propenyl, 2-propenyl, 1-butenyl, 2-butenyl, 3-butenyl, 1,-pentenyl, 2-pentenyl, 3-pentenyl, 4-pentenyl, 1-hexenyl, 2-hexenyl, 3-hexenyl, 4-hexenyl, or 5-hexenyl.

At step 54, the method 50 comprises alkylating the chitosan backbone of Formula 1 with a fatty acid chloride to obtain an adsorptive polymer matrix formed of a modified chitosan polymer having repeating units of the chitosan backbone. The adsorptive matrix thus obtained is in the form of a sponge. Suitable examples of fatty acid chloride include, but are not limited to, hexanoyl chloride, heptanoyl chloride, octanoyl chloride, nonanoyl chloride, and any esters, anhydrides, ethers, or amides thereof. In a preferred embodiment, the fatty acid chloride is at least one of octanoyl chloride and nonanoyl chloride.

In one embodiment, the alkylation of the chitosan backbone can be carried out at a temperature of 10 to 40° C., preferably 12 to 38° C., preferably 14 to 36° C., preferably 16 to 34° C., preferably 18 to 32° C., preferably 20 to 30° C., preferably 20 to 28° C., preferably 20 to 26° C., preferably 20 to 24° C., most preferably 20 to 22° C.

In some embodiments, the method of alkylating chitosan may comprise isolating the modified chitosan backbone and further subjecting the isolated modified chitosan backbone to a second round of alkylation with a fatty acid chloride. In one embodiment the fatty acid chloride utilized in the first and second round of alkylation is the same. In another embodiment the fatty acid chloride utilized in the first and second round of alkylation is different. In one embodiment, the degree of deacetylation of the modified chitosan polymer is about 50 to 95%, preferably 55 to 95%, preferably 60 to 95%, preferably 65 to 95%, preferably 70 to 95%, preferably 75 to 95%, preferably 80 to 95%, most preferably 85 to 95%.

At step 56, the method 50 comprises mixing the adsorptive polymer matrix with the dye-contaminated water. Mixing allows for adsorption to occur due to the contact between the adsorptive polymer matrix and the dye. In certain embodiments, the method further comprises agitation of the dye-contaminated water, including the adsorptive polymer matrix, before, during, and/or after the contacting. The agitation may encompass shaking, stirring, rotating, vibrating, sonication, and other means of increasing contact between the adsorptive polymer matrix and the dye. Further, the agitation can be performed manually or mechanically. In one embodiment, the treatment and contacting process may be enhanced by mechanical shaking or agitation, preferably by a bath shaker at a speed of up to 1000 rpm, preferably 50 to 950 rpm, preferably 100 to 900 rpm, preferably 150 to 850 rpm, preferably 200 to 800 rpm, preferably 250 to 750 rpm, preferably 300 to 700 rpm, preferably 300 to 650 rpm, preferably 300 to 600 rpm, preferably 300 to 550 rpm, preferably 300 to 500 rpm, preferably 300 to 450 rpm, preferably 300 to 400 rpm, preferably 300 to 350 rpm, most preferably 300 rpm. The contacting occurs for 10 to 30 hours, preferably 11 to 29 hours, preferably 12 to 28 hours, preferably 13 to 27 hours, preferably 14 to 26 hours, preferably 15 to 25 hours, preferably 16 to 24 hours, preferably 17 to 24 hours, preferably 18 to 24 hours, preferably 19 to 24 hours, preferably 20 to 24 hours, preferably 21 to 24 hours, preferably 22 to 24 hours, preferably 23 to 24 hours, most preferably 24 hours, in order to increase contact between the adsorptive polymer matrix and the dye. In one embodiment, the contacting and agitation occurs at a temperature of 10 to 40° C., preferably 12 to 38° C., preferably 14 to 36° C., preferably 16 to 34° C., preferably 18 to 32° C., preferably 20 to 30° C., preferably 20 to 28° C., preferably 20 to 26° C., preferably 20 to 24° C., most preferably 20 to 22° C. In some embodiments, the adsorptive polymer matrix has a maximum adsorption capacity (Qₘₐₓ) of 200 mg·g⁻¹ to 400 mg·g⁻¹, preferably 210 mg·g⁻¹ to 400 mg·g⁻¹, preferably 220 mg·g⁻¹ to 400 mg g⁻¹, preferably 230 mg·g⁻¹ to 400 mg·g⁻¹, most preferably 240 mg g⁻¹ to 400 mg g⁻¹, preferably 250 mg g⁻¹ to 400 mg·g⁻¹, preferably 260 mg·g⁻¹ to 400 mg g⁻¹, preferably 270 mg·g⁻¹ to 400 mg g⁻¹, preferably 280 mg·g⁻¹ to 400 mg·g⁻¹, preferably 290 mg·g⁻¹ to 400 mg g⁻¹, preferably 300 mg·g⁻¹ to 400 mg·g⁻¹, preferably 310 mg·g⁻¹ to 400 mg g⁻¹, preferably 320 mg g⁻¹ to 400 mg g⁻¹, preferably 330 mg·g⁻¹ to 400 mg g⁻¹, preferably 340 mg·g⁻¹ to 400 mg g⁻¹, preferably 350 mg·g⁻¹ to 400 mg g⁻¹, preferably 360 mg g⁻¹ to 400 mg g⁻¹, preferably 370 mg·g⁻¹ to 400 mg·g⁻¹, most preferably 380 mg·g⁻¹ to 400 mg·g⁻¹. In some embodiments, the adsorptive polymer matrix has an adsorption rate (k₂) of at least 1 mg g⁻¹ min⁻¹, at least 1.5 mg g⁻¹ min⁻¹, at least 2 mg g⁻¹ min⁻¹, at least 2.5 mg g⁻¹ min⁻¹, at least 3 mg g⁻¹ min⁻¹, at least 3.5 mg g 1 min⁻¹, at least 4 mg g⁻¹ min 1, at least 4.5 mg g 1 min⁻¹, at least 5 mg g⁻¹ min⁻¹, at least 5.5 mg g⁻¹ min⁻¹, at least 6 mg g⁻¹ min⁻¹, at least 6.5 mg g⁻¹ min⁻¹, at least 7 mg g⁻¹ min⁻¹, at least 7.5 mg g⁻¹ min⁻¹, at least 8 mg g⁻¹ min⁻¹, at least 8.5 mg g⁻¹ min⁻¹, at least 9 mg g⁻¹ min⁻¹. In some embodiments, the adsorptive polymer matrix has an adsorption rate (k₂) of 2 to 72 mg g⁻¹ min⁻¹.

In one embodiment, the absorptive polymer matrix is in the form of a sponge. In one embodiment, the sponge has an open-cell pore structure which forms an interconnected system of microchannels and micropores. The presence of the microchannels and micropores create a highly porous structure, resulting in a decreased density. In one embodiment, the sponge has a density of 0.001 to 0.1 g/cm³, preferably 0.005 to 0.05, preferably 0.01 to 0.13, preferably 0.04 to 0.12, preferably, most preferably 0.01 to 0.035 g/cm³ based on the total weight and total volume of the sponge inclusive of pore space. In another embodiment, the sponge has a porosity of at least 60%. In one embodiment, the sponge has a porosity of at least 65%, preferably at least 70%, preferably at least 75%, preferably at least 80%, preferably at least 85%, preferably at least 90%, preferably at least 92%, preferably 95 to 98% based on total pore volume and total volume of the sponge.

In one embodiment, the sponge comprises macrochannels and microchannels. In one embodiment, the macrochannels have an average diameter of 0.1 to 2 mm, preferably 0.2 to 1.9 mm, preferably 0.3 to 1.8 mm, preferably 0.4 to 1.7 mm, preferably 0.5 to 1.6 mm, preferably 0.6 to 1.5 mm, preferably 0.6 to 1.4 mm, preferably 0.6 to 1.3 mm, preferably 0.6 to 1.2 mm, preferably 0.6 to 1.1 mm, preferably 0.6 to 1.0 mm, most preferably 0.6 to 0.9 mm. In another embodiment, the microchannels have an average diameter of 100 to 200 μm, preferably 105 to 195 μm, preferably 110 to 190 μm, preferably 115 to 185 μm, preferably 120 to 180 μm, preferably 125 to 175 μm, preferably 130 to 170 μm, preferably 130 to 165 μm, preferably 130 to 160 μm, preferably 130 to 155 μm, preferably 130 to 150 μm, most preferably 130 to 145 μm.

In one embodiment, the sponge comprises micropores having a pore diameter of less than 100 μm and a pore wall thickness of less than 50 μm. In one embodiment, the sponge comprises pores with pore wall thicknesses of less than 50 μm, preferably less than 45 μm, preferably less than 40 μm, preferably less than 35 μm, preferably less than 30 μm, preferably less than 25 μm, most preferably less than 20 μm. In another embodiment, the sponge comprises pores with pore diameters of 1 to 100 μm, preferably 5 to 95 μm, preferably 5 to 90 μm, preferably 5 to 85 μm, preferably 5 to 80 μm, preferably 5 to 75 μm, preferably 5 to 70 μm, preferably 5 to 65 μm, preferably 5 to 60 μm, preferably 5 to 55 μm, preferably 5 to 50 μm, preferably 5 to 45 μm, preferably 5 to 40 μm, preferably 5 to 35 μm, preferably 5 to 30 μm, preferably 5 to 25 μm, preferably 5 to 20 μm, preferably 5 to 15 μm, preferably 5 to 10 μm, most preferably 5 μm. In another embodiment, a thickness of the sponge is at least 1 mm. In another embodiment, the thickness of the sponge is 1 mm to 100 mm, preferably 5 to 95 mm, preferably 5 to 90 mm, preferably 5 to 85 mm, preferably 5 to 80 mm, preferably 5 to 75 mm, preferably 5 to 70 mm, preferably 5 to 65 mm, preferably 5 to 60 mm, preferably 5 to 55 mm, preferably 5 to 50 mm, preferably 5 to 45 mm, preferably 5 to 40 mm, preferably 5 to 35 mm, preferably 5 to 30 mm, preferably 5 to 25 mm, preferably 5 to 20 mm, preferably 5 to 15 mm, most preferably 5 to 10 mm. In another embodiment, the sponge has an available specific surface area of greater than 100 cm²/g, preferably greater than 200 cm²/g, preferably greater than 300 cm²/g, preferably greater than 400 cm²/g, most preferably greater than 500 cm²/g.

In a preferred embodiment, the method further comprises recovering and reusing a dye-loaded modified chitosan polymer after contacting and filtering. In certain embodiments, the dye-loaded modified chitosan polymer may be obtained from the water with methods including, but not limited to, filtration, centrifugation, evaporation, heated evaporation, and the like, preferably filtration or centrifugation, most preferably filtration. In certain embodiments, the dye-loaded modified chitosan polymer may be washed several times with an appropriate solvent, preferably acetonitrile, to remove all materials present after each round of dye absorption before being regenerated and reused and/or recycled in another round of dye removal from water. In some embodiments, the adsorptive polymer matrix has a removal efficiency of a dye of at least 42%, preferably at least 50%, preferably at least 55%, preferably at least 60%, preferably at least 65%, preferably at least 70%, most preferably at least 75%. There may be an increase in the removal efficiency with increasing agitation speed. After regeneration, the sponge may be washed and rinsed at least once with a solvent to remove residual dye. The washed sponge may then be frozen at a temperature of at about 0° C., preferably about −2° C., preferably about −4° C., preferably about −6° C., preferably about −8° C., preferably about −10° C., preferably about −12° C., preferably about −14° C., preferably about −16° C., preferably about −18° C., most preferably about −20° C. The sponge is frozen for at least 36 h, preferably 2 to 34 h, preferably 4 to 32 h, preferably 6 to 30 h, preferably 8 to 28 h, preferably 8 to 26 h, preferably 8 to 24 h, preferably 8 to 22 h, preferably 8 to 20 h, preferably 8 to 18 h, preferably 8 to 16 h, preferably 8 to 14 h, preferably 8 to 12 h, most preferably 8 to 10 h. In one embodiment, the sponge may then be freeze-dried at a temperature of −65 to ˜105° C., preferably-70 to ˜100° C., preferably-75 to −95° C., preferably-80 to −90° C., most preferably-85° C. The sponge is freeze-dried for 8 to 24 h, preferably 8 to 22 h, preferably 8 to 20 h, preferably 8 to 18 h, preferably 8 to 16 h, preferably 8 to 14 h, preferably 8 to 12 h, most preferably 8 to 10 h to obtain the sponge. In an embodiment, the removal efficiency of the adsorptive polymer matrix decreases by less than 10% after a removal cycle.

The examples below are intended to further illustrate procedures for preparing and characterizing the modified chitosan polymer and assessing the method for dye removal using the modified chitosan polymer. They are not intended to limit the scope of the claims.

### EXAMPLES

The following examples demonstrate the preparation of modified chitosan sponges and its use for purifying dye-contaminated water. The examples are provided solely for illustration and are not to be construed as limitations of the present disclosure, as many variations thereof are possible without departing from the spirit and scope of the present disclosure.

### Example 1: Materials

Pristine chitosan with a medium molecular weight (190,000-310,000 g mol⁻¹) and a degree of deacetylation of 75-85%, acetic acid (99%), hexanoyl chloride (98%), heptanoyl chloride (99%), octanoyl chloride (99%), nonanoyl chloride (96%), methyl orange (MO), methylene blue (MB), Rhodamine B (RB), sodium hydroxide, and acetonitrile were procured from Merck (Germany) and used without any further purification. Distilled water was produced by the Millipore (Milli-Q Academic) water purification system.

### Example 2: Synthesis of the Modified Chitosan Sponge

The modified chitosan was prepared using a previously reported method. 1 g of chitosan was dissolved in 99 mL of acetic acid solution (0.693 mL acetic acid, 99.31 mL distilled water) and stirred for 48 hours at room temperature to ensure total solubility. The pH of the solution was maintained to 7 by a slow addition of sodium hydroxide (NaOH; 0.1 M, 100 mL). Afterward, 1 mL of fatty acid chloride was added dropwise to the reaction mixture and stirred at room temperature. After 2 hours of continuous stirring, the reaction solution was neutralized using 100 mL of 0.1 M NaOH. Then, the reaction mixture was filtered under vacuum and precipitated in acetonitrile. The stable gel was then washed with deionized water three times to remove residual acetic acid and, moved into a plastic centrifuge tube and, frozen overnight at −20° C., then treated via a freeze-drying process in an Edwards freeze dryer (−85° C.) overnight. Pristine chitosan sponge was also prepared following the same procedure for comparison purposes. A schematic illustration for the preparation of modified chitosan-based sponges and their dye removal application is presented in FIG. 1B.

### Example 3: Characterization

Fourier transform infrared (FTIR) analysis for pristine chitosan and its modified counterparts was carried out via Bruker INVENIO Series FTIR spectrometer in the range of 400-4000 cm⁻¹ to identify and confirm the functional groups. The thermal stability profile of all samples was analyzed through TGA technique in a TA instruments Q600 SDT apparatus. The temperature was increased gradually from 30° C. to 800° C. with a heating rate of 10° C. min⁻¹ under a continuous flow rate of nitrogen (20 mL min⁻¹). Wide angle X-ray diffraction (WXRD) was carried out using Pananalytical diffractometer model Empyrean Alphal at 20 kV and 40 mA, with Cu Kα (λ=1.54 Å) radiation source. The diffraction intensity was measured in the range of 20=4°-70° with a step size of 0.014° s⁻¹. Solid-state carbon nuclear magnetic resonance (13C-NMR) experiments were conducted in a Bruker NMR spectrometer operating at a ¹³C resonance frequency of 100.6 MHz. Samples were analyzed under magic-angle spinning (MAS) conditions using 4 mm zirconia rotors with Kel-F caps at a spinning frequency of 14 kHz. The morphology of the sponges were characterized by a scanning electron microscope (SEM) (JEOL JCM-7000).

### Example 4: Adsorption Experiments

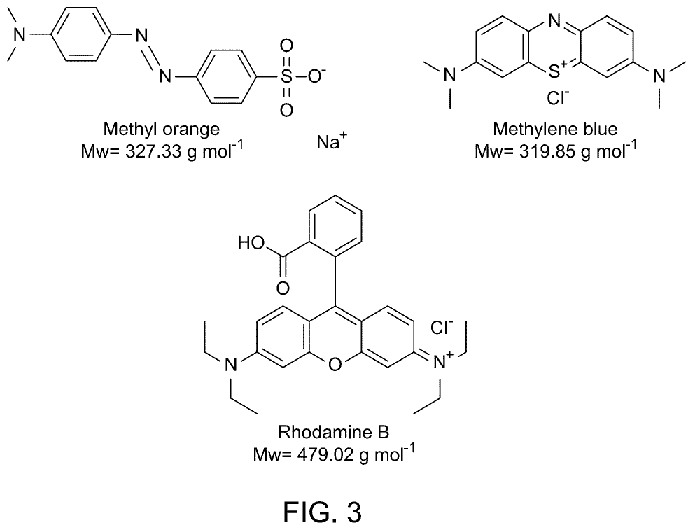

The adsorption experiments involved the utilization of one anionic dye (MO) and two cationic dyes (RB and MB), which underwent static adsorption procedures—the chemical structures of these dyes are provided in FIG. 3. Prior to conducting the adsorption experiments, calibration curves for each dye were generated using a spectrofluorometer (HORIBA Instruments Incorporated, Duetta). The adsorption studies were carried out in 20 mL glass vials with initial dye concentrations of C₀=5, 10, and 15 mg L⁻¹. In a typical procedure, 10 mg of sponge was introduced into a 10 mL aqueous solution containing the dyes. The solution was then agitated at 300 rpm for 24 hours at room temperature to achieve adsorption equilibrium. Following the removal of the modified chitosan sponge, the remaining solution underwent analysis using a spectrofluorometer at wavelengths of 464, 665, and 554 nm for methyl orange (MO), methylene blue (MB) and rhodamine B (RB), respectively. The adsorption capacity at equilibrium was calculated using the following equation (1):

$${q}_{e} = \frac{( {C}_{o} - {C}_{e} ) V}{m} \qquad ( 1 )$$

Where qₑ (mg g⁻¹) is the equilibrium adsorption capacity, C₀ (mg L⁻¹) is the initial concentration, Cₑ (mg L⁻¹) is the equilibrium concentration, V (L) is the volume of the aqueous solution, and m (g) is the used mass of adsorbent.

### Example 5: Selective Adsorption of Anionic and Cationic Dyes

A series of experiments were conducted to investigate the selective adsorption of sponges towards anionic and cationic dyes. The procedure involved adding the same volume and concentration of each dye to 20 mL glass vials. Subsequently, 10 mg of the sponge was added into the binary and ternary dye solutions as follows: mixture #1=MO+MB, mixture #2=MO+RB, and mixture #3=MO+MB+RB. The reaction mixtures were stirred magnetically at 300 rpm for 30 minutes. Then, 4 mL aliquots were collected from each sample, and spectrofluorometer spectra were recorded.

### Example 6: Kinetics and Batch Adsorption Experiments

The dye adsorption capacity of the sponges was tested using MO as the model dye. The adsorption test was carried out in batch conditions by immersing a fixed amount of sponge (10 mg) in 10 mL of dye solution with a concentration of 15 mg L⁻¹ in a set of 20 mL sealed bottles under constant stirring (300 rpm) at room temperature. The sample aliquot was withdrawn at different time intervals until it reached equilibrium. The amount of dye adsorbed by the sponges was determined by measuring the dye concentration in the solution before and after the adsorption experiment using a spectrofluorometer. The experimental quantity adsorbed at each time qₜ (mg g⁻¹), and removal efficiency R (%) were calculated using Eq. (2) and (3), respectively.

$${q}_{t} = \frac{( {C}_{o} - {C}_{t} ) V}{m} \qquad ( 2 )$$

$$R ( \% ) = \frac{( {C}_{o} - {C}_{t} )}{{C}_{o}} 100 \qquad ( 3 )$$

Where C₀ and Cₜ (mg L⁻¹) are the initial and at-times concentrations of MO, respectively. V (L) is the volume of the solution, and m (g) is the mass of the adsorbent.

### Example 7: Adsorption Kinetics

The pseudo-first-order and pseudo-second-order kinetic models were chosen to explicate MO's adsorption mechanism on modified chitosan sponges. The pseudo-first-order model can be formulated by eq. (4):

$$log ( {q}_{e} - {q}_{t} ) = log {q}_{e} - \frac{{k}_{1}}{2.303} t \qquad ( 4 )$$

The pseudo-second-order model can be formulated by eq. (5):

$$\frac{t}{{q}_{t}} = \frac{1}{{k}_{2} {q}_{e}^{2}} + \frac{1}{{q}_{e}} t \qquad ( 5 )$$

Where qₑ and qₜ (mg g⁻¹) are the quantity adsorbed of MO on the sponges at equilibrium and at various times t (min), respectively. k₁ and k₂ (g mg⁻¹ min⁻¹) refer to the rate constant of the pseudo-first-order and pseudo-second-order, respectively. The values of qₑ, k₁, and k₂ are determinable through the intercept and slope derived from plotting log (qₑ−qₜ) against t for the pseudo-first-order model and plotting t/qₜ against t for the pseudo-second-order model.

### Example 8: Adsorption Isotherms

Adsorption isotherms are functional, explaining the interaction mechanism of solution and sorbent. The adsorption experiments gathered the isotherm data under initial dye concentrations varying between 5-500 mg L⁻¹. The Langmuir and Freundlich models were employed to analyze the experimental data [I. Langmuir, The Adsorption of Gases on Plane Surfaces of Glass, Mica and Platinum., 40 J AM. CHEM. SOC'Y 1361-1403 (1918); H. Freundlich, Über Die Adsorption In Lösungen, 385-470 (1970)]. The equilibrium data of adsorbent was described by the Langmuir eq. (6):

$$qe = \frac{{Q}_{max} {K}_{L} {C}_{e}}{( 1 + {K}_{L} {C}_{e} )} \qquad ( 6 )$$

The Freundlich isotherm equation was described by Eq. (7)

$$qe = {k}_{f} {C}_{e}^{\frac{1}{n}} \qquad ( 7 )$$

Where qₑ (mg g⁻¹) is the MO amount adsorbed at equilibrium, Cₑ (mg L⁻¹) is the MO concentration in the solution at equilibrium, K_{L} is the Langmuir constant, qₘₐₓ (mg g⁻¹) is the maximum adsorption capacity of the adsorbent, K_{f} is the Freundlich constant, and n is the degree of surface heterogeneity. The 1/n values measure the favorability of adsorption; if n>1 suggests favorable adsorption, then the adsorption capacity increases, and new adsorption sites form.

### Example 8: Regeneration

50 mg of sponge was added to a solution containing 15 mg L⁻¹ of MO at room temperature and shaken at 100 rpm for 2 hours; the change in concentration before and after adsorption was measured. The sponge was removed, washed with acetone five times, and placed in a 20 mL vial. Subsequently, 10 mL of acetone was added and shaken at 80 rpm for 1 hour for desorption, which was repeated twice. The adsorption experiment was repeated 5 times at room temperature using the dried sample, and the recyclability of the sponge was evaluated based on the amount of cyclic adsorption.

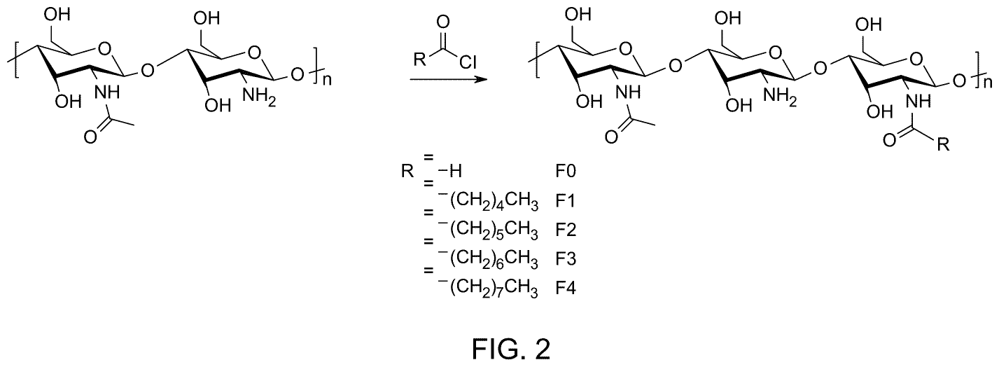

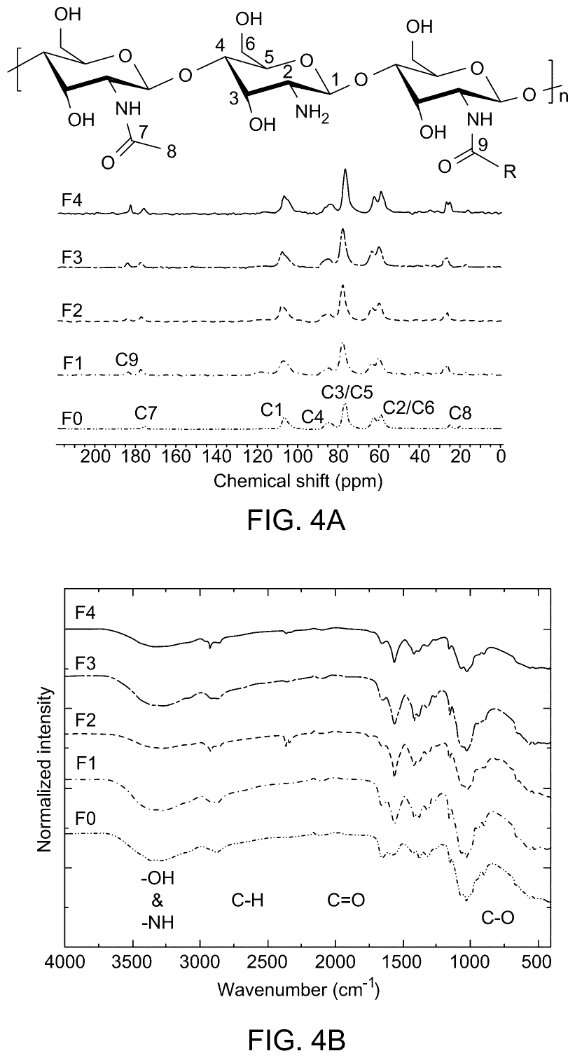

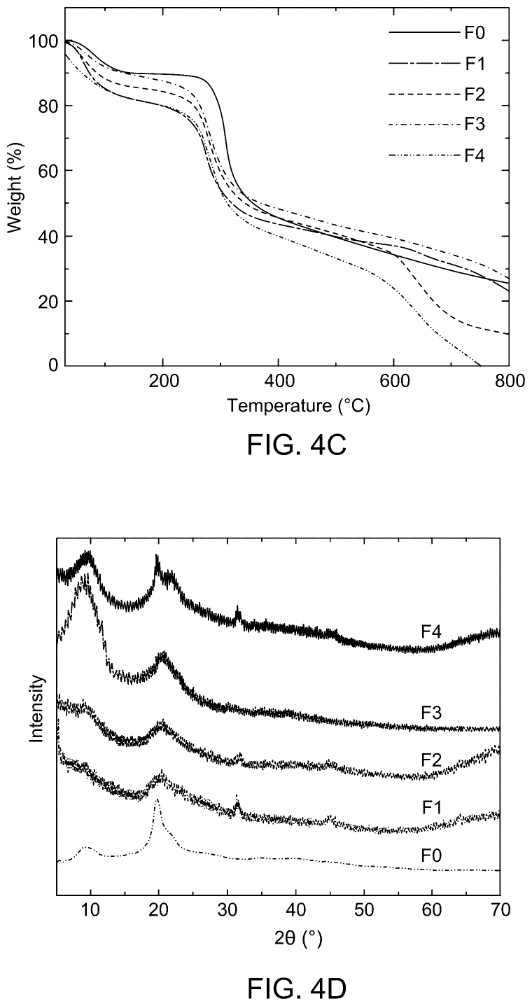

Four chitosan derivatives were synthesized via the reaction of chitosan with four distinct fatty acid chlorides, each possessing varying alkyl chain lengths, under ambient conditions in an aqueous environment. This synthesis involved a nucleophilic acyl substitution reaction between the primary amine moiety on the chitosan backbone and the acyl moiety of the fatty acid chlorides, resulting in the formation of amide functional groups and the attachment of alkyl chains onto the chitosan backbone (FIG. 2). The resultant polymers exhibited remarkable water stability (Table 1). Confirmation of successful alkyl chain substitution onto the chitosan backbone was achieved through solid-state 13C-NMR analysis, as illustrated in FIG. 4A. The appearance of a new peak at 27.6 ppm indicated the presence of the new alkyl chains, while the emergence of a peak at 182.5 ppm was attributed to the newly introduced C═O group, which agrees with NMR data in the literature.

TABLE 1
Solubility test of chitosan sponge and its
modified counterparts in water after 24 h.

| Foam | Modification | Solubility in water |
|---|---|---|
| F0 | — | Yes |
| F1 | Hexanoyl chloride | No |
| F2 | Heptanoyl chloride | No |
| F3 | Octanoyl chloride | No |
| F4 | Nonanoyl chloride | No |

Furthermore, the functional groups associated with the pristine and modified chitosan (F0-F4) were identified using FTIR spectroscopy, and the results are illustrated in FIG. 4B. The broad and strong peaks between 3000 and 3650 cm⁻¹ represent the —OH stretching and —NH groups. Peaks at 2850-2950 cm⁻¹ are attributed to C—H vibrations, while stretching vibrations of C═O (amide I) and bending vibrations of amide II (N—H) are observed at 1645 and 1565 cm⁻¹, respectively. However, the intensity of amide II in the modified chitosan increased compared to F0. The asymmetric stretching vibration of C—O—C and C—O were present at 1150 and 1070 cm⁻¹, respectively. Consequently, the FTIR spectra confirm the modification of amino groups in chitosan, where the corresponding peaks match those of non-modified chitosan. However, the increased relative intensity of peaks indicates a change in the degree of deacetylation.

The thermal stability of F0-F4 was evaluated by TGA and presented in FIG. 4C. In general, the thermal properties of chitosan and its derivatives were similar to cellulose, where it undergoes degradation rather than melting when exposed to high temperatures. All samples displayed two stages of decomposition. In the case of F0, the first decomposition step occurred below 180° C. and led to 12 wt. % due to moisture loss, while the second stage started at 270° C., leading to the breaking of the cycloaliphatic structure of the chitosan. However, the modified chitosan samples (F1-F4) exhibited slightly lower thermal stability due to long alkyl chains, which tend to degrade faster.

The morphology of modified and unmodified chitosan was investigated by wide-angle X-ray diffraction (WXRD) patterns and presented in FIG. 4D. The diffraction pattern of F0 exhibited an amorphous protuberance at 2θ=9.4°, along with a major crystalline peak around 2θ=19°. This peak is attributed to crystalline planes resulting from intra- and extra-hydrogen bonding. However, in the case of F1-F4, these peaks appeared broader than that of F0, indicating a loss of crystallinity in chitosan due to a decrease in hydrogen bonding. Furthermore, a new peak appeared at 2θ=31.4° in F1-F4, which could be attributed to the introduction of an alkyl chain to the chitosan structure. The decreased crystallinity of the modified chitosan can be attributed to the length of the pendant chain, which is long enough to inhibit hydrogen bonding but insufficient to promote hydrophobic stability. Consequently, the original ordered crystal structure of chitosan was destroyed and tended to become disordered, resulting in changes in the diffraction peaks. Similar findings have been reported indicating that the presence of substituent groups in the chitosan backbone slightly reduces the crystalline copolymer structure.

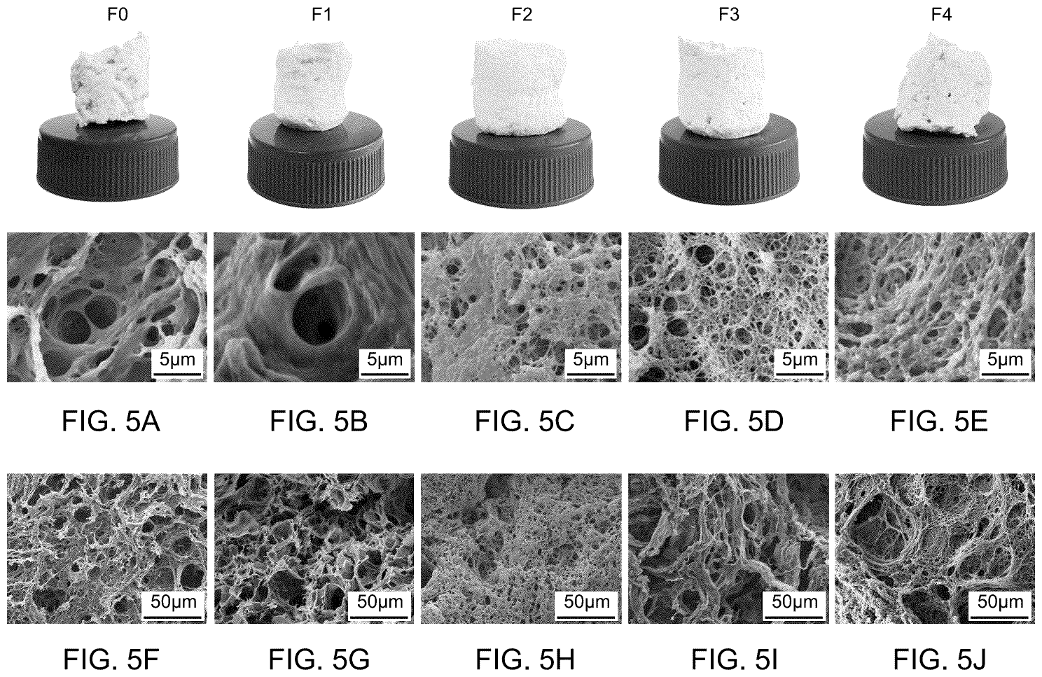

Pristine and modified chitosan polymers were converted into porous sponges using freeze-drying at −85° C. The actual appearance of the sponges is presented in FIG. 5A-FIG. 5J, which demonstrated good mechanical properties and stability. Thus, SEM analysis was employed to investigate the internal porous network structure of the chitosan sponge and its derivatives (i.e., F0-F4), as reported in FIG. 5A to FIG. 5J. All sponges exhibited a porous network structure that makes the material applicable for adsorbing pollutants from water. It is worth mentioning that modifying chitosan with long alkyl chains increases its hydrophobicity and makes it water-stable. On the other hand, it was found that F0 is water-soluble and cannot be used for dye removal applications as it totally dissolves in water after 24 hours. Therefore, only the modified chitosan-based sponges were utilized for the water treatment application.

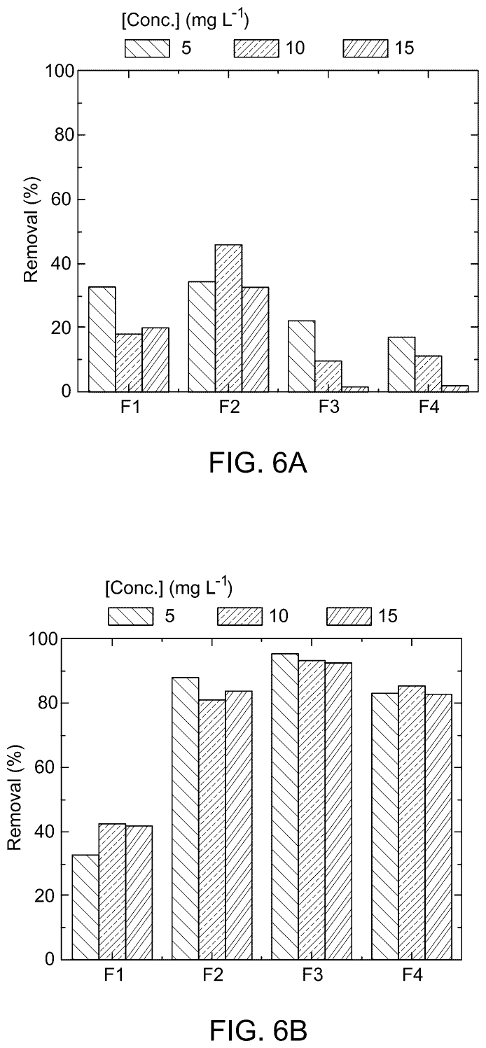

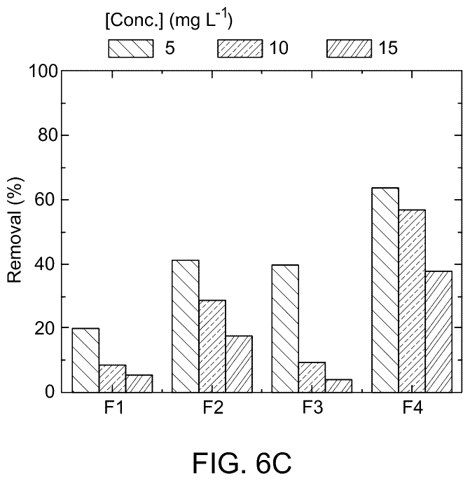

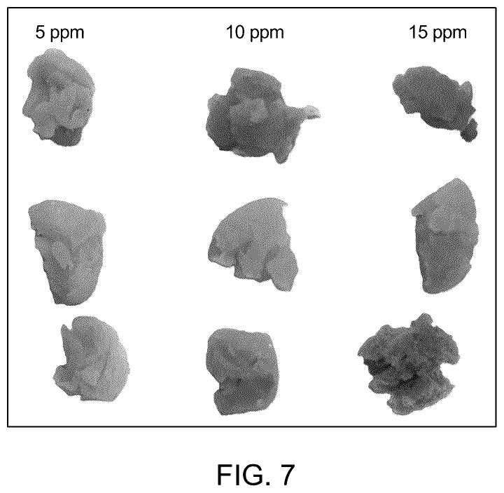

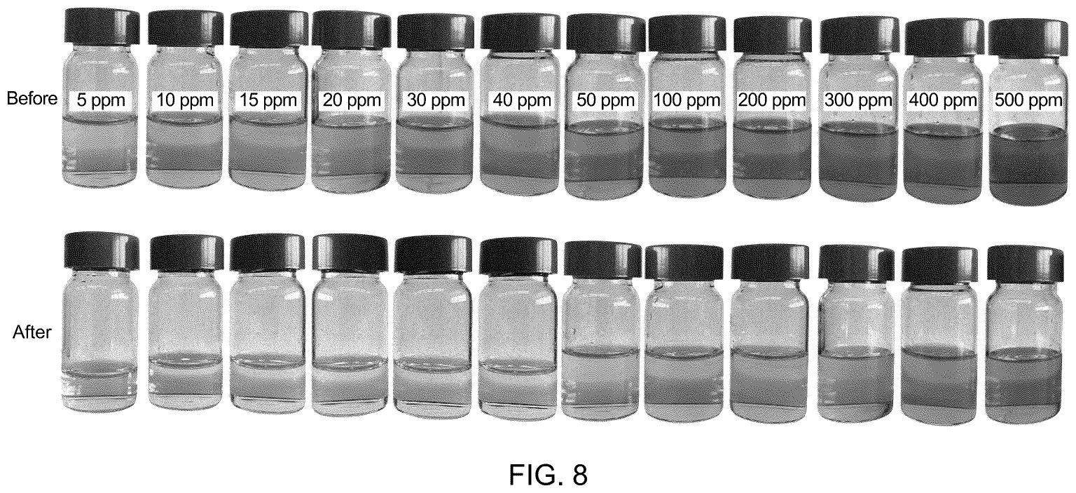

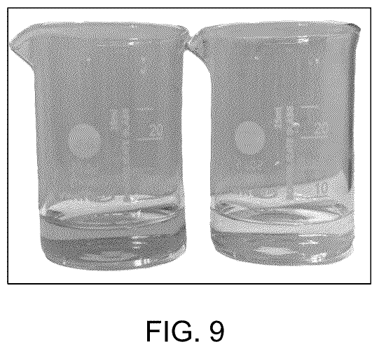

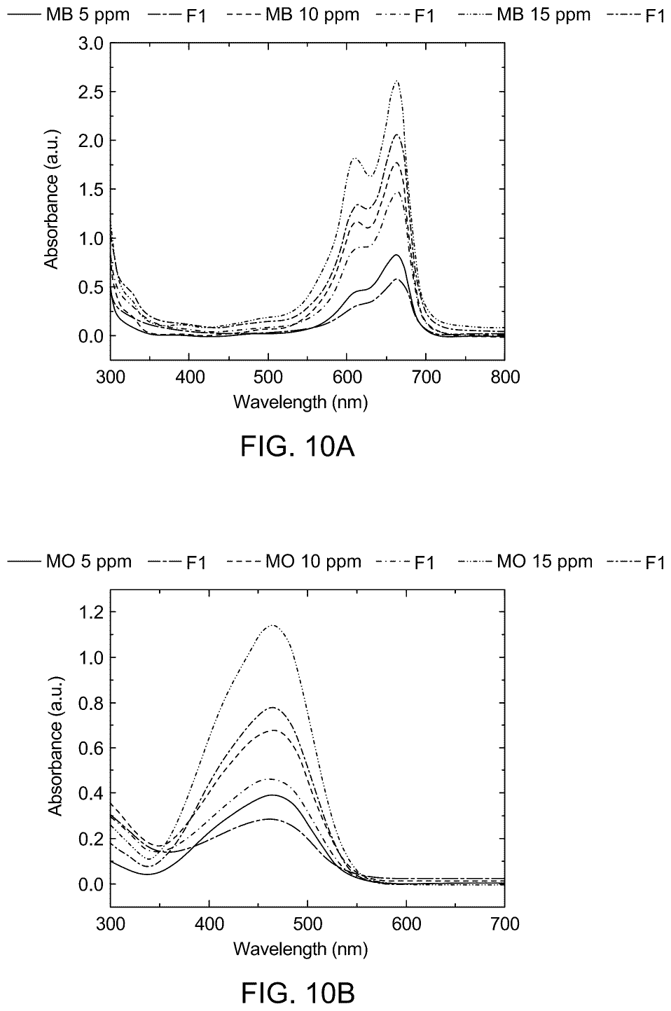

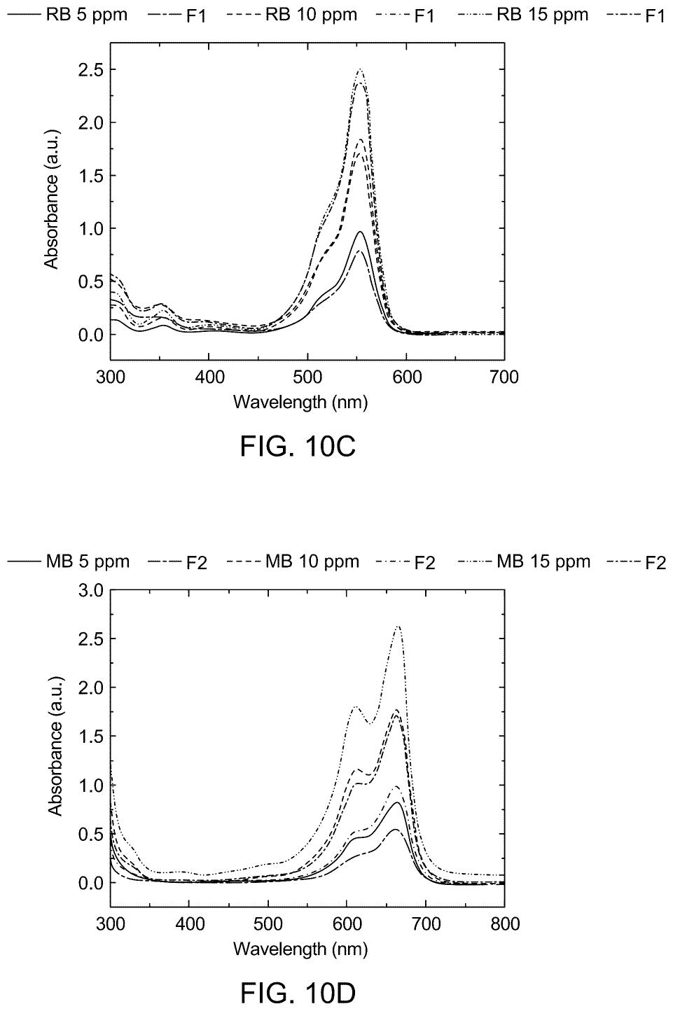

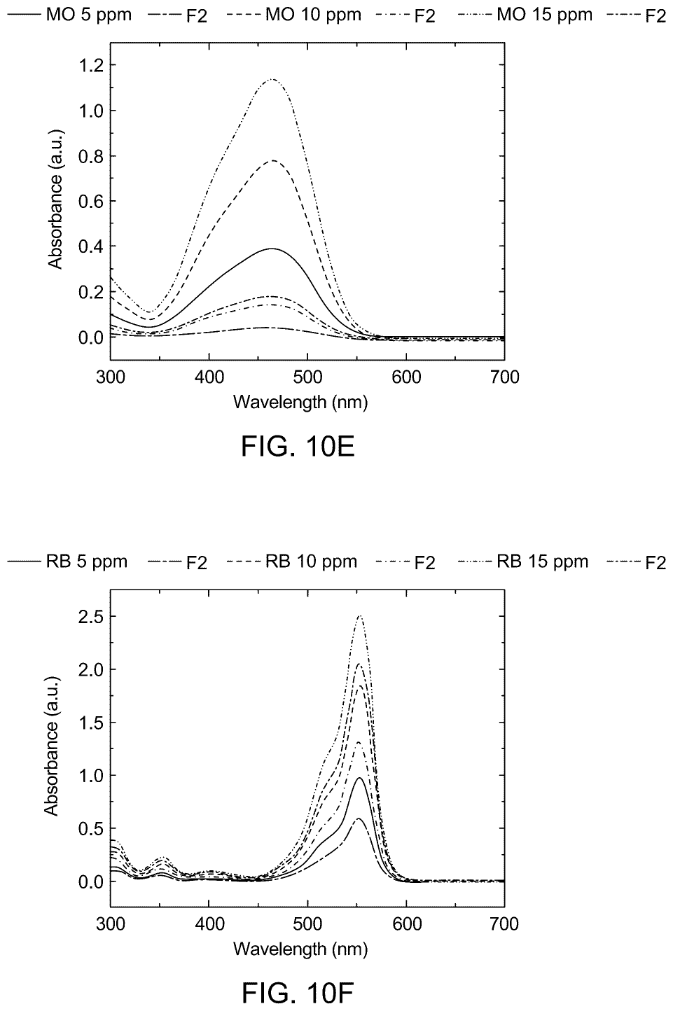

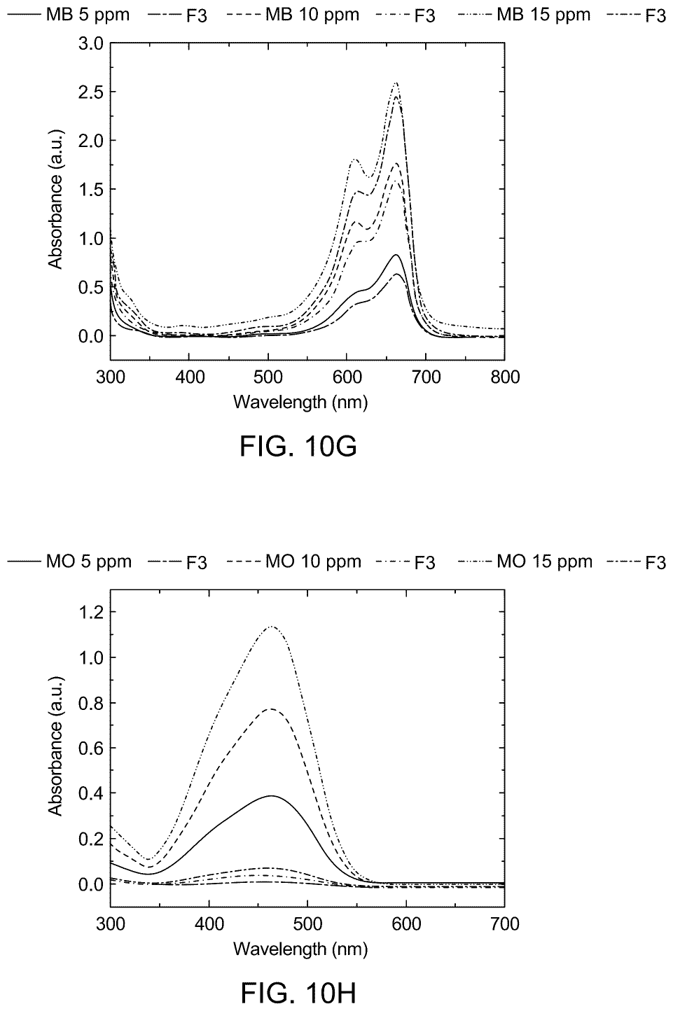

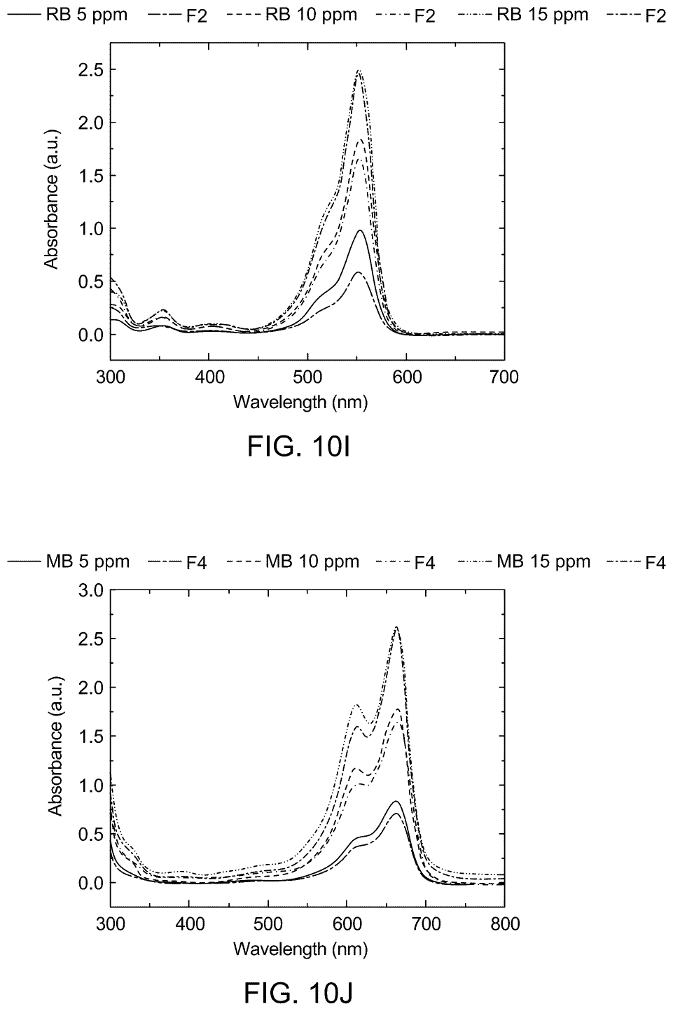

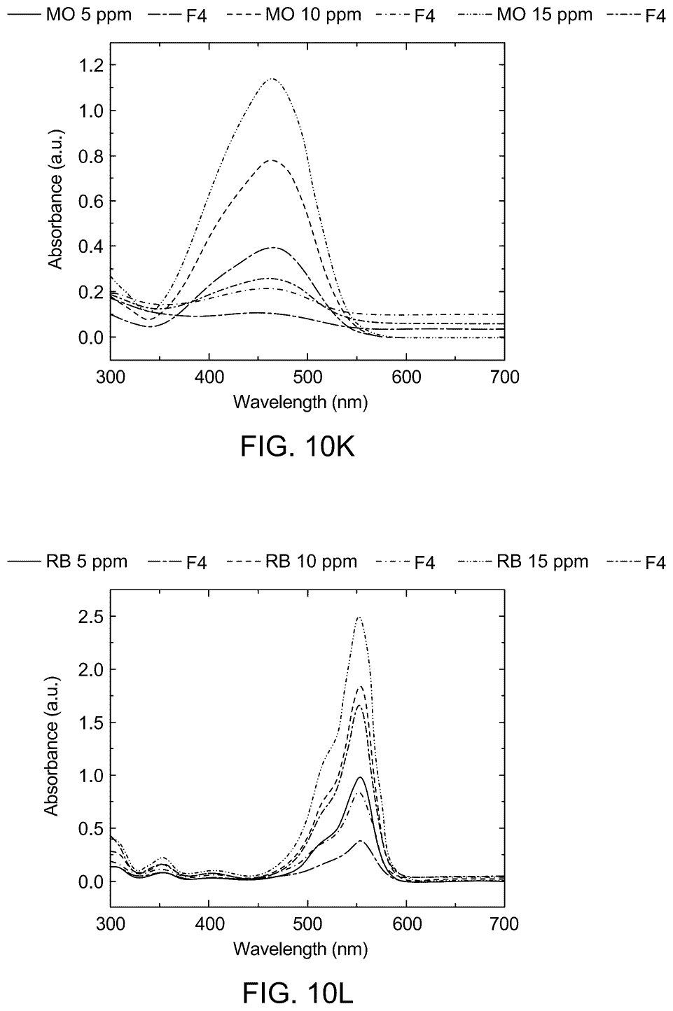

To evaluate the adsorption performance of the prepared chitosan-based sponges, the adsorption capacities of three different dyes (i.e., MO, RB, and MB) were determined (FIG. 6A to FIG. 6C). The obtained results demonstrated that under the same experimental conditions, these sponges exhibit significantly higher adsorption rates for anionic dyes compared to cationic ones. The removal efficiencies of MO using modified chitosan sponges (F1-F4) were found to be 41.86%, 83.57%, 92.43%, and 82.60%, for F1, F2, F3, and F4, respectively (FIG. 6B, FIG. 7, and FIG. 8), whereas the removal efficiencies for MB and RB were relatively lower compared to MO, respectively (FIG. 6A and FIG. 6C). Additionally, a direct filtration experiment using F3 sponge in a syringe was conducted and found that more than 90% of MO was removed as presented in FIG. 6B and FIG. 9. This indicates that the sponges have the potential to adsorb dyes selectively. The UV absorbance spectra showing removal of MB, MO, and RB dyes using modified chitosan sponges after 24 hrs is depicted in FIG. 10A to FIG. 10L.

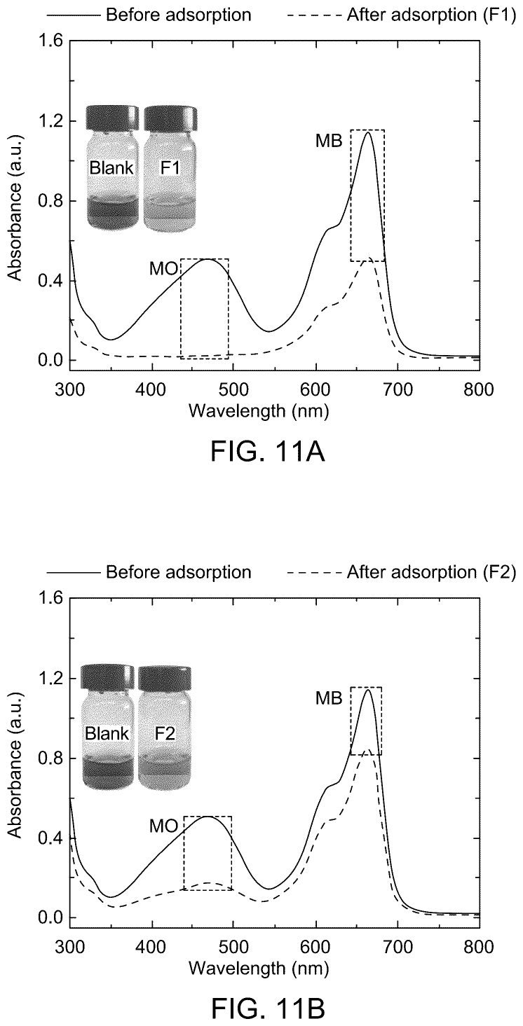

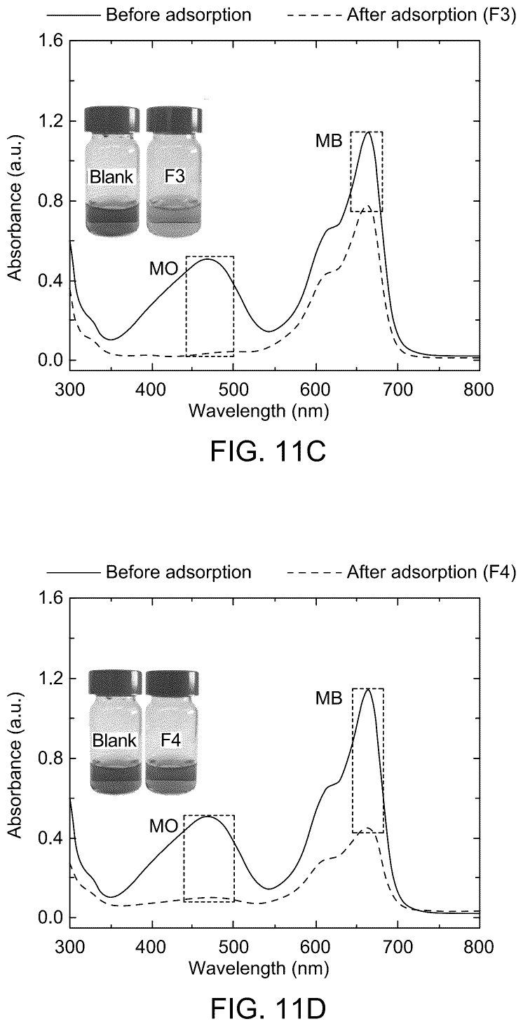

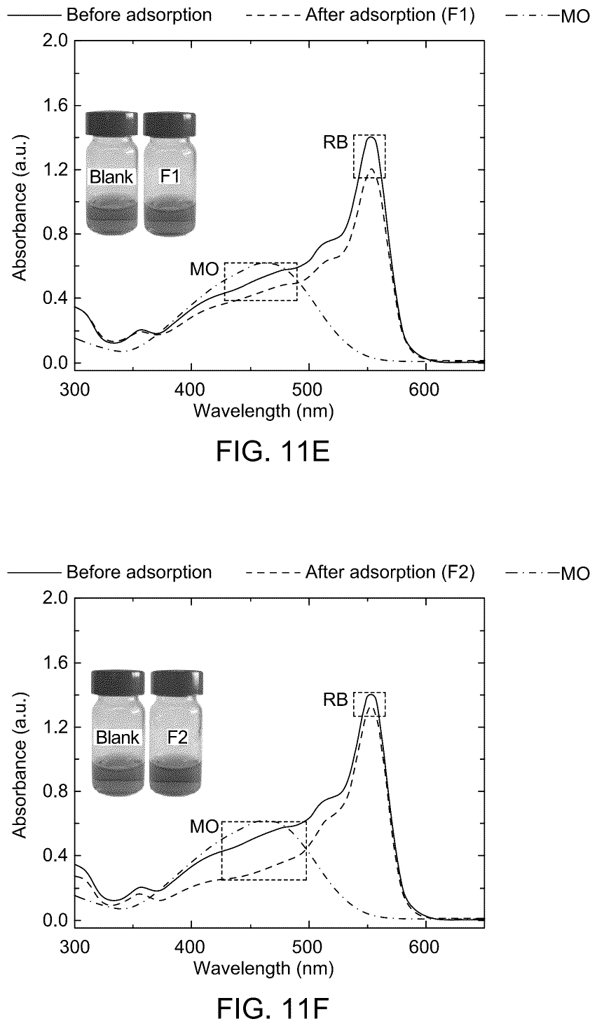

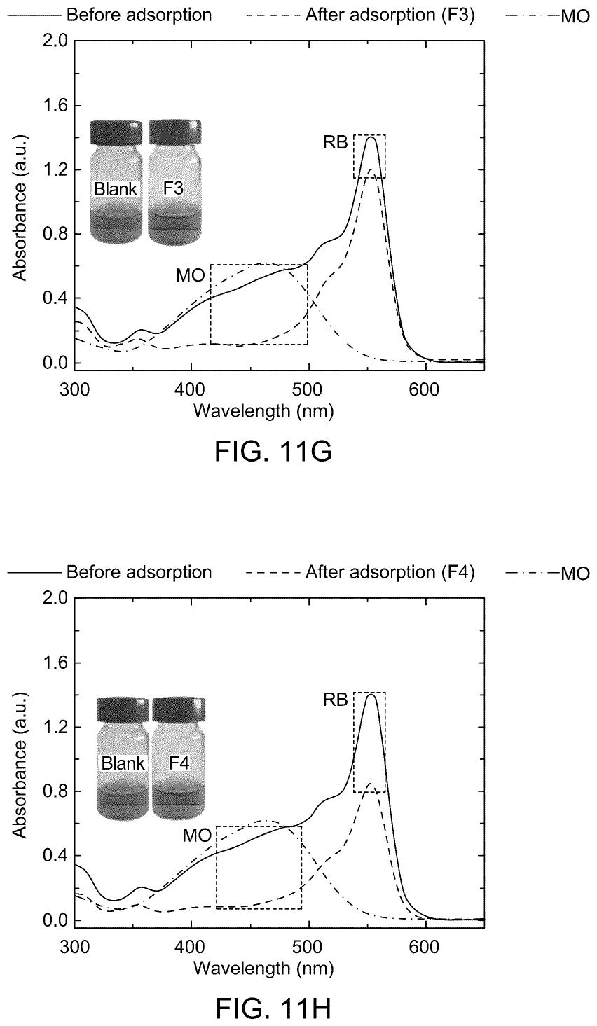

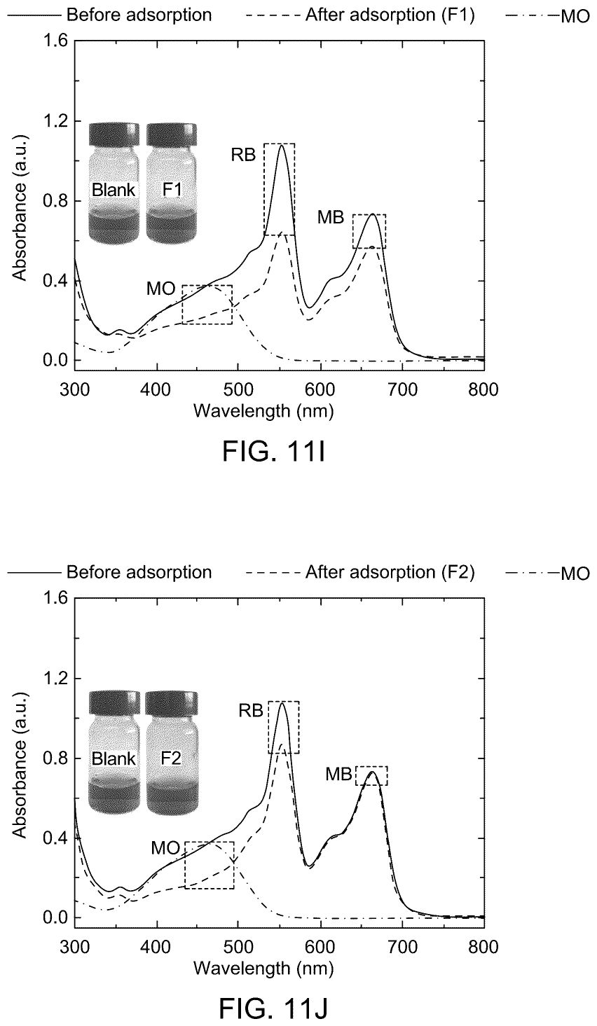

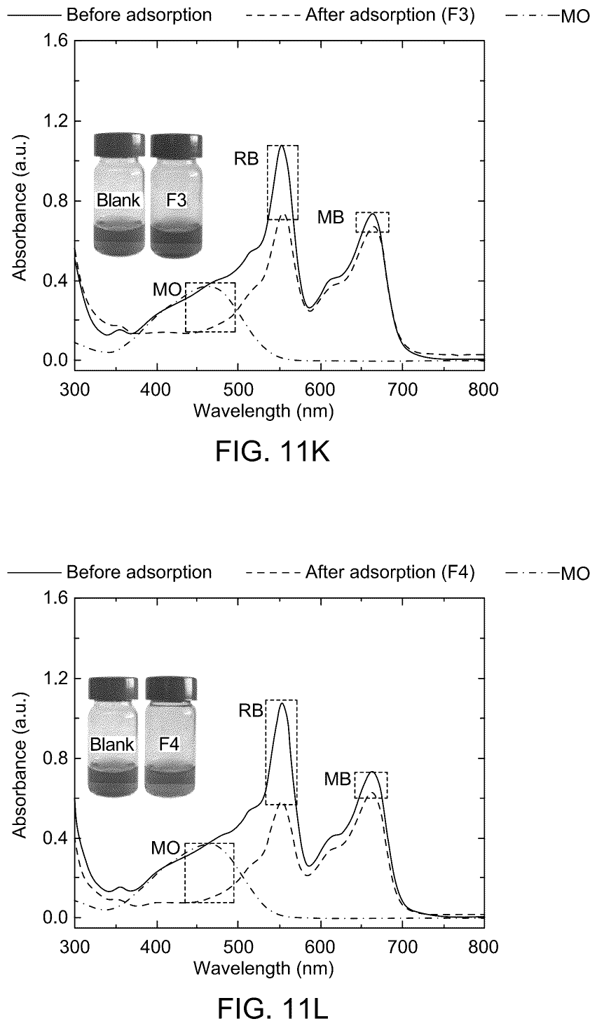

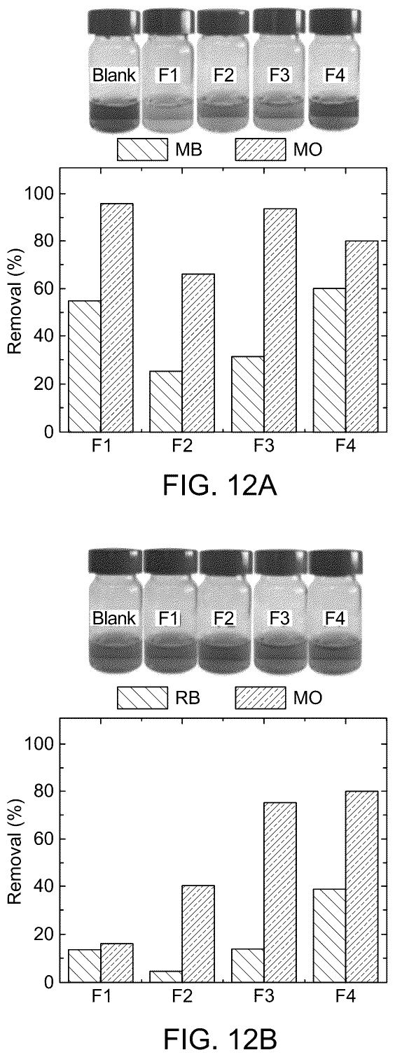

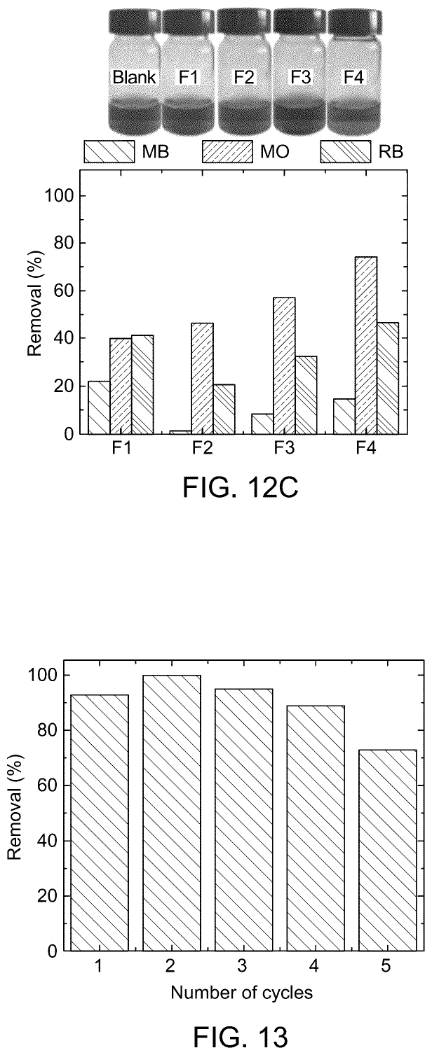

To verify the high selectivity of the sponges toward anionic dyes, the sponges were tested using binary and ternary dye solutions of equal volumes at a concentration of 15 mg L⁻¹, and the visible spectrum of the mixture was recorded. As shown in FIG. 11A to FIG. 11D, the absorption peak of MO at 464 nm vanishes within 30 min, while it only experiences a decrease in the case of MB at 665 nm. Additionally, at the end of the experiment, the solution's color turns into blue, indicating the domination of MB. As compared to blank solution F1 displayed a removal efficiency of 95.5% for MO, while it displayed 54.9% removal of MB (FIG. 11A, FIG. 12A). Conversely, solution F3 displayed greater selectivity towards MO, demonstrating a three-fold removal efficiency for MO (93.5%) compared to MB (31.7%) (FIG. 11C, FIG. 12A). This suggests that the chemical structure of the modified chitosan can be adjusted to fine-tune selectivity in binary mixtures.

Similarly, when examining the mixture of MO and RB, the sponges displayed higher removal efficiency of MO relative to RB (FIG. 11E to FIG. 11H). For instance, a notable reduction in the absorption peak at 464 nm was observed with F3 (FIG. 11G) and F4 (FIG. 11H), resulting in MO removal efficiency of 75.2% and 79.5%, respectively (FIG. 12B). While the removal efficiency of RB was found to be 14.3% and 39.3% for F3 and F4, respectively. This suggests a selectivity factor of 5 for the adsorption of MO/RB with F3 and F2 for F4. Interestingly, F2 exhibited the highest selectivity factor of 8, despite its MO removal efficiency not exceeding 40%. These findings underscore the importance of controlling the chemical structure of modified chitosan, as varying chain lengths can enhance the removal effectiveness of specific dye mixtures.

A ternary mixture composed of the same volume and concentration of MB, MO, and RB was prepared and used to further validate the selective removal of the anionic dye from a mixture of dyes. For all sponges, the UV spectra showed that the absorption peak at 464 nm (representing MO) decreased notably, while the absorption peaks at 554 nm and 665 nm, corresponding to RB and MB, respectively, were slightly changed, as presented in FIG. 11I through FIG. 11L. In the ternary mixture, the removal efficiency of MO was found to be 40.2%, 46.6%, 57.3%, and 74% for F1, F2, F3, and F4, respectively (FIG. 12C). Interestingly, the efficiency increased as the chain length of the fatty acid chlorides increases, which could be attributed to the increase in the hydrophobicity of the sponges. Moreover, MB demonstrated the lowest removal efficiency among the three dyes, with a maximum removal capacity of 22.3% for F1. Although F3 and F4 showed higher efficiencies than F2, F2 demonstrated superior selectivity. For instance, F2 displayed a selectivity factor of 32 for MO/MB and 2 for MO/RB. In contrast, F4 demonstrated a selectivity factor of 5 for MO/MB and 1.6 for MO/RB. These findings show that the adsorption capacity and selectivity can be easily tuned by tailoring the chemical modification of the chitosan polymer.

Recycling and reusing of adsorbents are also essential factors in the dye removal field because of economic and ecological demands for sustainability. The reusability test was evaluated through a simple procedure involving sponge washing and soaking in acetone. The results revealed a decrease in the removal efficiency from 93% to 73%, which could be attributed to the occupation of active sites (FIG. 13). Nonetheless, the findings demonstrated that the prepared sponges retained the ability to remove a high percentage of dye even after undergoing five cycles, indicating their potential for repeated utilization in the removal of MO.

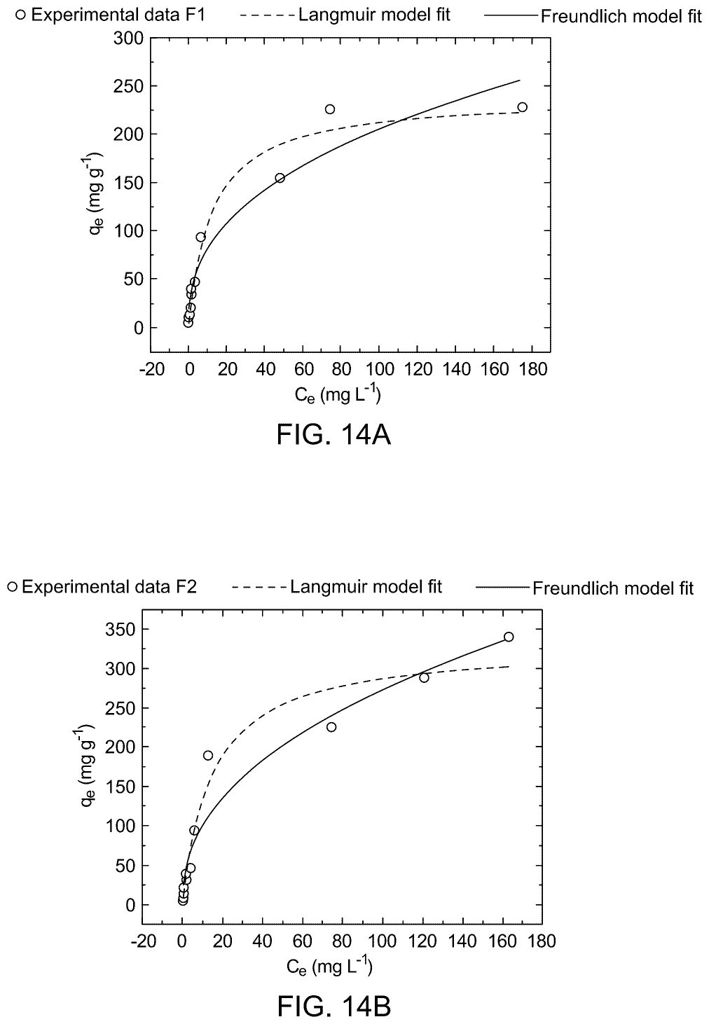

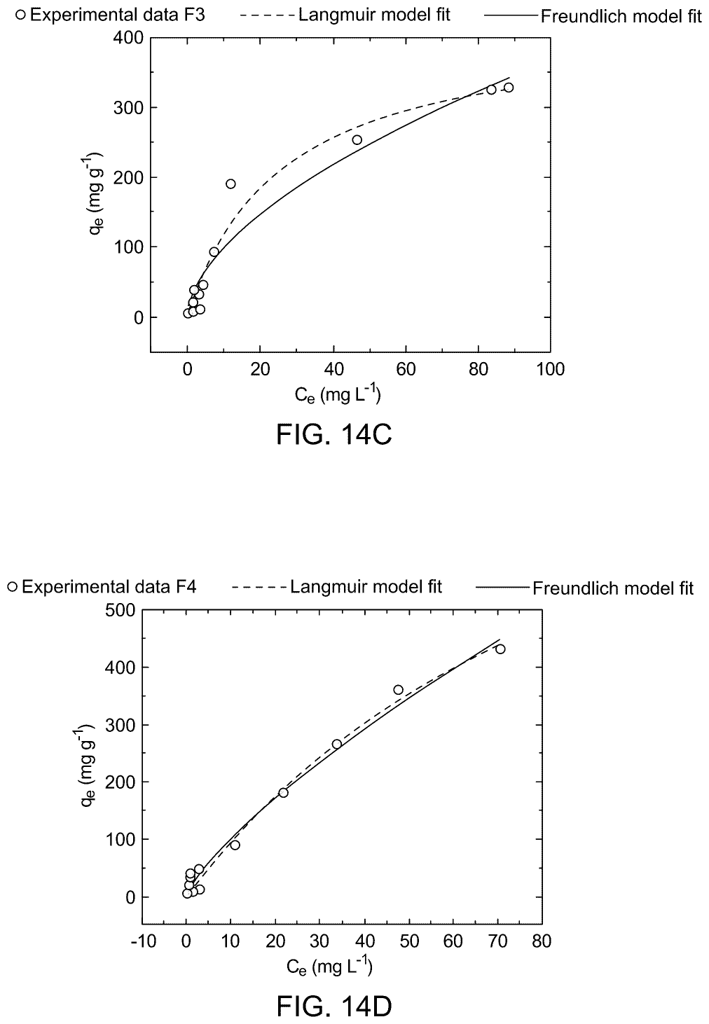

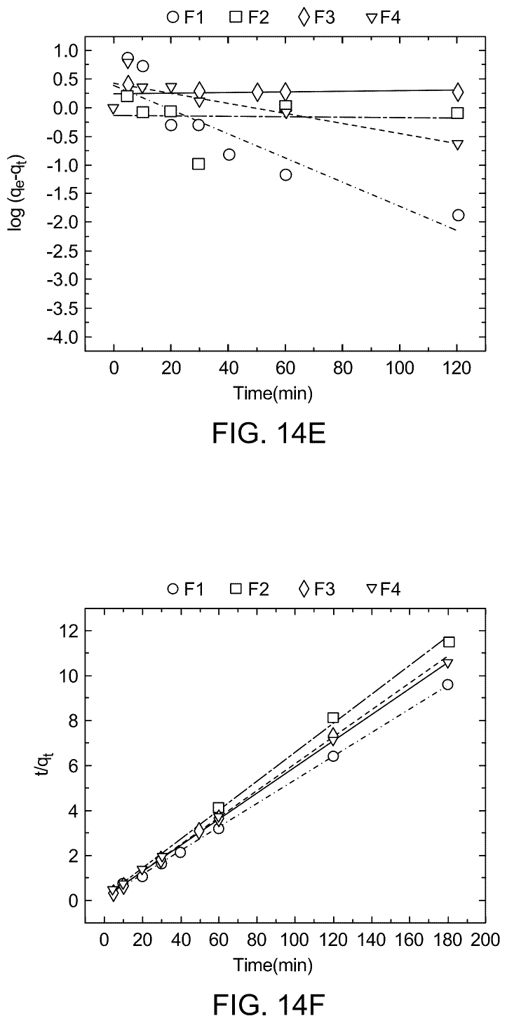

Adsorption isotherms are crucial for developing the adsorption mechanism paths correlating the surface characteristics and adsorbent capacities. To study the adsorption equilibrium, the experimental data for the batch adsorption studies were fitted in two commonly used isotherms, Langmuir's and Freundlich's nonlinear models. The Langmuir isotherm theory assumed monolayer coverage of adsorbate over a homogenous adsorbent surface, while Freundlich assumed multilayer coverage over heterogeneous surfaces. Due to the fast kinetics of the chitosan sponges' adsorption, which almost reached equilibrium within 30 minutes, a dye concentration between 5 and 500 mg L⁻¹ was studied. The adsorption isotherms of MO are presented in FIG. 14A-FIG. 14F and Table 2. All sponges demonstrated better fitting with the Langmuir model, indicating monolayer coverage over the surface of homogenous adsorbent (sponge). The maximum adsorption capacities (Qₘₐₓ) were achieved as follows: 238 mg g⁻¹, 380 mg g⁻¹, 331 mg g⁻¹ and 346 mg g⁻¹ for F1, F2, F3, and F4, respectively. Interestingly, varying the chain length significantly changed the sponges' adsorption capacity without following a specific trend.

TABLE 2
Adsorption isotherm parameters of chitosan-based sponges.

| | Langmuir model | | | Freundlich model | | |
|---|---|---|---|---|---|---|
| Adsorbent | Qₘₐₓ (mg g⁻¹) | K_{L} | R² | K_{f} (mg g⁻¹) | n | R² |
| F1 | 238 | 0.081 | 0.97 | 32.67 | 2.50 | 0.93 |
| F2 | 380 | 0.039 | 0.96 | 26.75 | 1.76 | 0.93 |
| F3 | 331 | 0.066 | 0.96 | 36.73 | 2.29 | 0.94 |
| F4 | 346 | 0.009 | 0.99 | 17.60 | 0.76 | 0.99 |

TABLE 3
Adsorption kinetics parameters of chitosan-based sponges.

| | | | Pseudo-first-order | | | Pseudo-second-order | | |
|---|---|---|---|---|---|---|---|---|
| | Removal | q_{e exp} | k₁ | | | k₂ | | |
| Adsorbent | (%) | (mg g⁻¹) | (min⁻¹) | q_{e cal} | R² | (mg g⁻¹ min⁻¹) | q_{ecal} | R² |
| F1 | 100 | 18.8 | 0.0527 | 3.3 | 0.8381 | 4.20 | 19.0 | 0.99 |
| F2 | 83 | 15.1 | 0.0005 | 1.5 | 0.0004 | 9.57 | 15.6 | 0.99 |
| F3 | 88 | 16.4 | 0.0124 | 2.2 | 0.7691 | 71.70 | 16.6 | 1 |
| F4 | 91 | 16.7 | 0.0246 | 3.8 | 0.9076 | 2.00 | 17.3 | 0.99 |

To further understand the adsorption behavior of the sponges, adsorption kinetics were evaluated to understand the adsorption rate and correlate it with the adsorbent characteristic. The pseudo-first-order (PFO) kinetics elucidate diffusion processes, while pseudo-second-order kinetics (PSO) define the sorption capacity of the adsorbent. Typically, most adsorbents exhibit rapid adsorption rates, reaching nearly 80% within 30 minutes. Experimental data on the adsorption of chitosan-based sponges were analyzed using the pseudo-first-order (PFO) and pseudo-second-order (PSO) models and summarized in Table 3. Results indicate that the experimental data align more closely with the pseudo-second-order model, as evidenced by the higher R² values. Moreover, the calculated qₑ values from the PSO model closely match experimental values, suggesting that the adsorption kinetics of MO and the sponges may be primarily governed by direct adsorption.

TABLE 4
Performance comparison of F1-F4 relative to previously
reported chitosan-based adsorbents.

| | | Qₘₐₓ | Rate | |
|---|---|---|---|---|
| Adsorbent | Adsorbate | (mg g⁻¹) | constant (k₂) | Ref |
| Chitosan film | MO | 476 | 0.000746 | S. Hussain, et. al., Adsorption, |
| Chitosan/Zeolite | MO | 287 | 0.000125 | kinetics and thermodynamics |
| (CSZ3) film | | | | studies of methyl orange dye |
| | | | | sequestration through |
| | | | | chitosan composites films, Int |
| | | | | J Biol Macromol 168 (2021) |
| | | | | 383-394 |
| Chitosan/PVA/ | MO | 153 | 0.08 | U. Habiba, et. al., Adsorption |
| Zeolite | | | | study of methyl orange by |
| | | | | chitosan/polyvinyl |
| | | | | alcohol/zeolite electrospun |
| | | | | composite nanofibrous |
| | | | | membrane, Carbohydr Polym |
| | | | | 191 (2018) 79-85 |
| Chitosan | MO | 207 | — | L. Zhai, et al., Fabrication of |
| microspheres | | | | chitosan microspheres for |
| | | | | efficient adsorption of methyl |
| | | | | orange, Chin J Chem Eng 26 |
| | | | | (2018) 657-666 |
| Natural chitosan | MB | 46.23 | — | L. Fan, et al., Fabrication of |
| membranes | | | | novel magnetic chitosan |
| | | | | grafted with graphene oxide |
| | | | | to enhance adsorption |
| | | | | properties for methyl blue, J |
| | | | | Hazard Mater 215-216 |
| | | | | (2012) 272-279 |
| Graphene | MB | 275.5 | 0.0002 | C. Qi, L. Zhao, Y. Lin, D. Wu, |
| oxide/Chitosan | | | | Graphene oxide/chitosan |
| | | | | sponge as a novel filtering |
| | | | | material for the removal of |
| | | | | dye from water, J Colloid |
| | | | | Interface Sci 517 (2018) 18-27 |
| Magnetic | MB | 98.5 | 0.096 | L. Fan, et al., Fabrication of |
| chitosan/Graphene | | | | novel magnetic chitosan |
| oxide (MCGO) | | | | grafted with graphene oxide |
| | | | | to enhance adsorption |
| | | | | properties for methyl blue, J |
| | | | | Hazard Mater 215-216 |
| | | | | (2012) 272-279 |
| F1 | MO | 238 | 4.20 | This work |
| F2 | MO | 380 | 9.57 | This work |
| F3 | MO | 331 | 71.70 | This work |
| F4 | MO | 346 | 2.00 | This work |

The newly developed chitosan-based sponges displayed similar or even higher adsorption capacity of MO relative to previously reported chitosan-based adsorbent, with a high adsorption rate (Table 4). For instance, F2 demonstrated an adsorption capacity of 380 mg g⁻¹, which is 83% higher than the capacity obtained from microspheres chitosan adsorbent. Additionally, F2 displayed 150% higher adsorption capacity of MO, relative to the mixed-matrix adsorbent prepared from chitosan/PVA/zeolite. Surprisingly, as the alkyl chain side, incorporated to the chitosan backbone, increases from C5 to C7 (F1-F3), a notable increase in the initial adsorption rate was observed (from 4.2 to 71.7 mg g⁻¹ min⁻¹), which might be attributed to the increase in the polymer chain spacing which allows more molecules to diffuse easily to the internal surface of sponges. However, a further increase in the alkyl chain to C8 led to a significant reduction in the initial rate in the case of F4 (2 mg g⁻¹ min⁻¹), which could be attributed to the increase in hydrophobicity of the sponges, resulting in a lower interaction between the sponge and the dye in aqueous solution. Thus, the dye molecules' attraction to the internal sponges' surface becomes slower. Although some of the initial rates seem high, but similar rates were observed for different type of materials in literature. This study shows the significant important for controlling the modification of chitosan with various alkyl chains to enhance their water stability and improve the adsorption capability.

Numerous modifications and variations of the present disclosure are possible in light of the above teachings. It is therefore to be understood that within the scope of the appended claims, the invention may be practiced otherwise than as specifically described herein.

1. A method of purifying dye-contaminated water, comprising:
alkylating a chitosan backbone of Formula 1 with a fatty acid chloride to obtain an adsorptive polymer matrix formed of a modified chitosan polymer having repeating units of the chitosan backbone 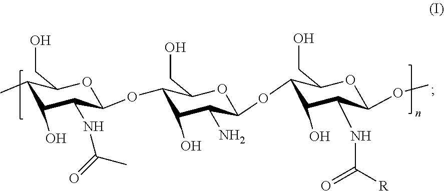
and
mixing the adsorptive polymer matrix with the dye-contaminated water while agitating at a temperature 15 to 35° C. to contact the adsorptive polymer matrix with the dye-contaminated water,
wherein the adsorptive polymer matrix is in the form of a sponge,
wherein R represents an alkyl chain comprising 5 to 8 carbons, and
wherein n represents a positive integer greater than 0.

2. The method of claim 1, wherein the adsorptive polymer matrix has a maximum adsorption capacity (Qₘₐₓ) of 2θ0 mg·g⁻¹ to 400 mg·g⁻¹.

3. The method of claim 1, wherein the modified chitosan polymer has a degree of deacetylation of at least 60%.

4. The method of claim 1, wherein the adsorptive polymer matrix has a maximum adsorption capacity (Qₘₐₓ) of 238 mg·g⁻¹ to 380 mg·g⁻¹.

5. The method of claim 1, wherein the modified chitosan polymer has a degree of deacetylation of at least 75%.

6. The method of claim 1, wherein the adsorptive polymer matrix has a removal efficiency of a dye of at least 42%.

7. The method of claim 1, wherein the dye is selected from the group consisting of methyl orange, methylene blue, and rhodamine B.

8. The method of claim 1, wherein a removal efficiency of the adsorptive polymer matrix decreases by less than 10% after a removal cycle.

9. The method of claim 1, wherein the adsorptive polymer matrix has an adsorption rate (k₂) of 2 to 72 mg g⁻¹ min⁻¹.

10. The method of claim 1, wherein the alkyl chain comprises 8 carbons.

11. The method of claim 1, further comprising:
deacetylating chitin with a monoprotic acid to obtain the chitosan backbone.

12. The method of claim 1, wherein the chitosan backbone is maintained at a pH of 6 to 8 during the alkylating.

13. The method of claim 1, wherein the fatty acid chloride is selected from the group consisting of hexanoyl chloride, heptanoyl chloride, octanoyl chloride, and nonanoyl chloride.

14. The method of claim 1, wherein the fatty acid chloride is octanoyl chloride.

15. The method of claim 11, wherein the monoprotic acid is selected from the group consisting of acetic acid (CH₂COOH), hydrochloric acid (HCl), nitric acid (HNO₃), formic acid (CH₂O₂), and hydrofluoric acid (HF).

16. The method of claim 11, wherein the monoprotic acid is acetic acid.

17. The method of claim 1, further comprising:
filtering a reaction mixture formed by the alkylating to obtain the modified chitosan polymer, then precipitating the modified chitosan polymer from an acetonitrile solution, and
drying the modified chitosan polymer to obtain the sponge.

18. The method of claim 17, wherein the modified chitosan polymer is dried at a temperature of −65 to ˜105° C. for 8 to 24 h.

19. The method of claim 1, wherein the agitating occurs at an agitation speed of 150 to 450 rotations per minute (rpm) for 8 to 36 h.

20. The method of claim 1, wherein the agitating occurs at an agitation speed of 300 rpm for 24 h.
